(19) United States
(12) Patent Application Publication
(10) Pub. No.: US 2026/0252604 A1
(43) Pub. Date: Aug. 27, 2026

(54) METHODS FOR GENERATING INSTRUCTIONAL CONTENT AND CONVERSATIONAL ARTIFICIAL INTELLIGENCE SYSTEMS THEREOF

(71) Applicant: GIDR.AI, Inc., The Colony, TX (US)

(72) Inventors: Chetan Gandhi, New York, NY (US); Sajeel Hussain, Allen, TX (US); Samuel Waicberg, The Colony, TX (US); Fritz Ebner, Pittsford, NY (US)

(21) Appl. No.: 19/547,433

(22) Filed: Feb. 23, 2026

Related U.S. Application Data
(60) Provisional application No. 63/761,701, filed on Feb. 21, 2025.
(60) Provisional application No. 63/761,699, filed on Feb. 21, 2025.
(60) Provisional application No. 63/761,697, filed on Feb. 21, 2025.

(51) Int. Cl. G06F 16/3329; G06Q 10/087; G06V 20/52

(52) U.S. Cl. CPC G06F 16/33295; G06Q 10/08726; G06V 20/52

(57) ABSTRACT

Conversational artificial intelligence systems and methods are disclosed that in some examples generate a guided procedure by applying machine learning models to enterprise data. The guided procedure steps are each associated with required structured fields and a validator. Interaction with a conversational agent application is monitored during guided procedure execution to maintain a procedure state vector comprising an indication of a current step and a completion status for the required structured fields. Evidence data obtained via the conversational agent application is analyzed against at least one rule of the validator for the current step to determine that the rule is satisfied. The procedure state vector is updated to thereby permit the conversational agent application to proceed to a next step upon determining each of the required structured fields for the current step has been completed. An auditable execution record is stored upon determining that the guided procedure has been completed.

### CROSS-REFERENCE TO RELATED APPLICATIONS

This application claims the benefit of priority of U.S. Provisional Patent Application Serial No. 63/761,697, filed on February 21, 2025, entitled “Methods For Voice-Enabled Natural Language Structuralized Data Entry And Systems Thereof,” U.S. Provisional Patent Application Serial No. 63/761,699, filed on February 21, 2025, entitled “Methods For Analyzing Service Management Interactions And Reporting Systems Thereof,” and U.S. Provisional Patent Application Serial No. 63/761,701, filed on February 21, 2025, entitled “Methods For Generating Instructional Content And Conversational Artificial Intelligence Systems Thereof,” the entire contents of each which is hereby incorporated by reference herein.

### FIELD

This technology generally relates to conversational intelligence systems for automated generation of instructional content in conversationally manageable steps and monitoring and auditing execution of tasks in accordance with the instructional content.

### BACKGROUND

Field Service technicians inspect and repair systems in uncontrolled environments and generally complete complex service tasks in the field. Due to a shortage of experienced technicians, new technicians often need extra assistance to complete these tasks.

Existing service ticket management systems (e.g., the ServiceNow^{TM} platform offered by ServiceNow, Inc. of Santa Clara, CA) provide details on a service task to complete but the information is often incomplete and does not provide step-by-step instructions that are manageable for the technician. Additionally, current service management systems do not effectively manage the steps performed during the completion of the service task nor obtain or provide any auditable information regarding the performance of the service task.

### SUMMARY

In some examples, the disclosed technology includes a method implemented by one or more conversational artificial intelligence systems and comprising generating a guided procedure by applying one or more machine learning models to enterprise data obtained from one or more enterprise data sources via one or more communication networks. The guided procedure comprises a plurality of steps each associated with one or more required structured fields and at least one validator. Interaction with a conversational agent application at a user device is monitored during execution of the guided procedure by a user of the user device to maintain a procedure state vector comprising at least an indication of a current one of the steps and a completion status for the required structured fields. Evidence data obtained via the conversational agent application is analyzed against at least one rule of the validator for the current one of the steps to determine that the rule is satisfied. The conversational agent application is configured to prompt the user to submit the evidence data based on an evidence type of the validator for the current one of the steps. The procedure state vector is updated to thereby permit the conversational agent to proceed to a next one of the steps upon determining, based on the monitoring, that each of the required structured fields for the current one of the steps has been completed. An auditable execution record is stored upon determining via the conversational agent application that the guided procedure has been completed. The auditable execution record comprises the completion statuses, the evidence data, and metadata associated with completion of the guided procedure.

In these examples, the required structured fields can collectively comprise a checklist, the evidence data can comprise an image, and the method can further comprise applying another one or more machine learning models to the image to determine whether the rule is satisfied. The metadata can comprise one or more of an identity of the user, a location of the user device upon completion of the guided procedure, or a time of completion of the guided procedure.

The method can further comprise automatically ordering a part via an application programming interface to a third-party part supplier system when an inventory level of the part is determined to be below a threshold based on a query to a parts inventory system. The part can be identified as required for the guided procedure based on a service ticket obtained from a service ticket platform. The method can also comprise generating, and outputting via the communication networks to another user device for display in response to an audit request received from the other user device, an audit trail dashboard comprising at least a portion of the auditable execution record and at least another portion of a plurality of other auditable execution records associated with other guided procedures and other users.

In these examples, the one of the completion statuses can indicate a failure and the method can further comprise generating and providing compliance data in response to a compliance request received from another user device via the communication networks. The compliance request can include an identity of the user and the one of the completion statuses retrieved from the auditable execution record based on the identity of the user. When the one of the completion statuses indicates a failure, the method can further comprise applying another one or more machine learning models to the enterprise data to generate training data for the user and the guided procedure based at least in part on the one of the completion statuses. The training data can comprise one or more best practices associated with the guided procedure, one or more core principles for achieving compliance with respect to the guided procedure, or an enhancement procedure comprising a plurality of other steps.

In other examples, a conversational artificial intelligence system is disclosed that comprises memory having instructions stored thereon and one or more processors configured to execute the stored instructions to generate a guided procedure by applying one or more machine learning models to enterprise data obtained from one or more enterprise data sources via one or more communication networks and, wherein the guided procedure comprises a plurality of steps each associated with one or more required structured fields and at least one validator. Interaction with a conversational agent application at a user device is monitored during execution of the guided procedure by a user of the user device to maintain a procedure state vector comprising at least an indication of a current one of the steps and a completion status for the required structured fields. Evidence data obtained via the conversational agent application is analyzed against at least one rule of the validator for the current one of the steps to determine that the rule is not satisfied. The conversational agent application is configured to prompt the user to submit the evidence data based on an evidence type of the validator for the current one of the steps. The procedure state vector is updated to thereby permit the conversational agent application to proceed to a next one of the steps upon determining, based on the monitoring, that each of the required structured fields for the current one of the steps has been completed and the rule has been satisfied in a subsequent iteration based on other evidence data. An auditable execution record is stored upon determining via the conversational agent application that the guided procedure has been completed. The auditable execution record comprises the completion statuses, the evidence data, and metadata associated with completion of the guided procedure and one of the completion statuses for the current one of the steps indicates a failure.

In these examples, the metadata can comprise one or more of an identity of the user, a location of the user device upon completion of the guided procedure, or a time of completion of the guided procedure. The evidence data can comprise one or more of a video, sensor measurement, timestamp, or location and the enterprise data comprises one or more user manuals, service manuals, or product documentation. The processors can be further configured to execute the stored instructions to generate, and output via the communication networks to another user device for display in response to an audit request received from the other user device, an audit trail dashboard comprising at least a portion of the auditable execution record and at least another portion of a plurality of other auditable execution records associated with other guided procedures and other users.

The processors can also be further configured to execute the stored instructions to generate and provide compliance data in response to a compliance request received from another user device via the communication networks. The compliance request includes an identity of the user and the one of the completion statuses retrieved from the auditable execution record based on the identity of the user. Additionally, the processors can be further configured to execute the stored instructions to apply another one or more machine learning models to the enterprise data to generate training data for the user and the guided procedure based at least in part on the one of the completion statuses.

In yet other examples, one or more non-transitory computer readable media are disclosed that have stored thereon instructions comprising executable code that, when executed by one or more processors, causes the processors to generate a guided procedure by applying one or more machine learning models to enterprise data obtained from one or more enterprise data sources via one or more communication networks. The guided procedure comprises a plurality of steps each associated with one or more required structured fields and at least one validator. Interaction with a conversational agent application at a user device is monitored during execution of the guided procedure by a user of the user device to maintain a procedure state vector comprising at least an indication of a current one of the steps and a completion status for the required structured fields. The required structured fields collectively comprise a checklist. An image obtained via the conversational agent application is analyzed against at least one rule of the validator for the current one of the steps based on an application of another one or more machine learning models to the image to determine that the rule is satisfied. The conversational agent application is configured to prompt the user to submit the image based on an evidence type of the validator for the current one of the steps. The procedure state vector is updated to thereby permit the conversational agent application to proceed to a next one of the steps upon determining, based on the monitoring, that each of the required structured fields for the current one of the steps has been completed. An auditable execution record is stored upon determining via the conversational agent application that the guided procedure has been completed. The auditable execution record comprises the completion statuses, the image, and metadata associated with completion of the guided procedure.

In these examples, the metadata can comprise one or more of an identity of the user, a location of the user device upon completion of the guided procedure, or a time of completion of the guided procedure. The executable code, when executed by the processors, can further cause the processors to automatically order a part via an application programming interface to a third-party part supplier system when an inventory level of the part is determined to be below a threshold based on a query to a parts inventory system. The part can be identified as required for the guided procedure based on a service ticket obtained from a service ticket platform.

The executable code, when executed by the processors, can further cause the processors to generate, and output via the communication networks to another user device for display in response to an audit request received from the other user device, an audit trail dashboard comprising at least a portion of the auditable execution record and at least another portion of a plurality of other auditable execution records associated with other guided procedures and other users. One of the completion statuses can indicate a failure and the executable code, when executed by the processors, can further cause the processors to generate and provide compliance data in response to a compliance request received from another user device via the communication networks. The compliance request includes an identity of the user and the one of the completion statuses retrieved from the auditable execution record based on the identity of the user.

One of the completion statuses can indicate a failure and the executable code, when executed by the processors, can further cause the processors to apply another one or more machine learning models to the enterprise data to generate training data for the user and the guided procedure based at least in part on the one of the completion statuses. The training data can comprise one or more best practices associated with the guided procedure, one or more core principles for achieving compliance with respect to the guided procedure, or an enhancement procedure comprising a plurality of other steps.

### BRIEF DESCRIPTION OF THE FIGURES

The accompanying drawings, which are incorporated in and form a part of the specification, illustrate exemplary embodiments and together with the written description serve to explain the principles, characteristics, and features of the technology. In the drawings:

FIG. 1 is a block diagram of exemplary network environment with a conversational artificial intelligence system, in accordance with at least one aspect of the present disclosure;

FIG. 2 is a block diagram of exemplary conversational artificial intelligence system, in accordance with at least one aspect of the present disclosure;

FIG. 3 is a flowchart of an exemplary method for data ingestion, in accordance with at least one aspect of the present disclosure;

FIG. 4 is a flowchart of an exemplary method for receiving and processing an input or other query, in accordance with at least one aspect of the present disclosure;

FIG. 5 illustrates exemplary user input annotated images, in accordance with at least one aspect of the present disclosure;

FIG. 6 is a flowchart of an exemplary method for generating step-by-step instructional content or a multi-part answer comprising smaller bits of information, in accordance with at least one aspect of the present disclosure;

FIG. 7 is a flowchart of an exemplary method for facilitating reporting of service task step completion, in accordance with at least one aspect of the present disclosure;

FIG. 8 is a flowchart of an exemplary method for inventory management, in accordance with at least one aspect of the present disclosure;

FIG. 9 is a flowchart of an exemplary method for service ticket ingestion, in accordance with at least one aspect of the present disclosure;

FIGS. 10-14 are screenshots illustrating an exemplary work order task workflow, in accordance with at least one aspect of the present disclosure;

FIGS. 15-34 are screenshots illustrating an exemplary procedure workflow, in accordance with at least one aspect of the present disclosure;

FIG. 35 is a screenshot of an exemplary audit trail dashboard, in accordance with at least one aspect of the present disclosure;

FIG. 36 illustrates screenshots of exemplary compliance interfaces, in accordance with at least one aspect of the present disclosure;

FIG. 37 illustrates screenshots of exemplary training interfaces, in accordance with at least one aspect of the present disclosure;

FIG. 38 is a screenshot of an exemplary compliance dashboard, in accordance with at least one aspect of the present disclosure;

FIG. 39 is a block diagram of exemplary interaction management system, in accordance with at least one aspect of the present disclosure;

FIG. 40 is a flow diagram of another exemplary method for data ingestion, in accordance with at least one aspect of the present disclosure;

FIG. 41 is a flow diagram of an exemplary method of frequently asked question updating, in accordance with at least one aspect of the present disclosure;

FIG. 42 is a screenshot of an exemplary trending topics interface, in accordance with at least one aspect of the present disclosure;

FIG. 43 is a screenshot of an exemplary billing inquiry quality assurance interface, in accordance with at least one aspect of the present disclosure;

FIG. 44 is a screenshot of an exemplary trending topics analytics interface, in accordance with at least one aspect of the present disclosure;

FIG. 45 is a flow diagram of exemplary workflow steps with a reflection pattern, in accordance with at least one aspect of the present disclosure;

FIG. 46 is a flow diagram of exemplary workflow steps without a reflection pattern, in accordance with at least one aspect of the present disclosure;

FIG. 47 is a flow diagram of an exemplary method for real-time interaction updating and answer generation, in accordance with at least one aspect of the present disclosure;

FIG. 48 is a flow diagram of an exemplary method for facilitating efficient service query responses based on both agent and customer QA pairs, in accordance with at least one aspect of the present disclosure;

FIG. 49 is a flow diagram of an exemplary method for retraining a machine learning model, in accordance with at least one aspect of the present disclosure;

FIG. 50 is a flow diagram of an exemplary method for generating training materials, in accordance with at least one aspect of the present disclosure;

FIG. 51 is a block diagram of exemplary structuralization system, in accordance with at least one aspect of the present disclosure;

FIG. 52 is a flow diagram of an exemplary method for voice-enabled natural language structuralized data entry, in accordance with at least one aspect of the present disclosure;

FIG. 53 is a flow diagram of an exemplary method for receiving and processing an input or other query, in accordance with at least one aspect of the present disclosure;

FIG. 54 illustrates an exemplary prompt to a large language model, in accordance with at least one aspect of the present disclosure;

FIG. 55 illustrates an exemplary transcript of an interaction between an artificial intelligence chatbot system and a user of a data entry user device resulting from large language model prompt execution, in accordance with at least one aspect of the present disclosure;

FIG. 56 illustrates another exemplary prompt to a large language model, in accordance with at least one aspect of the present disclosure;

### DETAILED DESCRIPTION

This disclosure is not limited to the particular systems, devices, and methods described, as these may vary. The terminology used in the description is for the purpose of describing exemplary versions or embodiments only and is not intended to limit the scope.

The terms “algorithm,” “system,” “module,” “engine,” or “architecture,” if used herein, are not intended to be limiting of any particular implementation for accomplishing and/or performing the actions, steps, processes, etc., attributable to and/or performed thereby. An algorithm, system, module, engine, and/or architecture may be, but is not limited to, software, hardware and/or firmware or any combination thereof that performs the specified functions including, but not limited to, any use of a general and/or specialized processor in combination with appropriate software loaded or stored in a machine-readable memory and executed by the processor.

Further, any name associated with a particular algorithm, system, module, and/or engine is, unless otherwise specified, for purposes of convenience of reference and not intended to be limiting to a specific implementation. Additionally, any functionality attributed to an algorithm, system, module, engine, and/or architecture may be equally performed by multiple algorithms, systems, modules, engines, and/or architectures incorporated into and/or combined with the functionality of another algorithm, system, module, engine, and/or architecture of the same or different type, or distributed across one or more algorithms, systems, modules, engines, and/or architectures of various configurations.

The disclosed technology relates to systems and methods for generating step-by-step content to walk users through the generated content in conversationally manageable subparts. In some examples, the technology generates and manages step-by-step instructions from a user query and an unstructured answer to the user query. In other examples, this technology generates and manages a task from a service ticket and returns to a service ticket management system details of the actions taken after completion of the task.

For example, a service ticket may specify a checklist of items to check and the conversational artificial intelligence (AI) system 102 of this technology will generate step-by-step instructions to complete the checklist items, provide them to a user in a conversational manner, collect steps taken from the user, and return steps taken to the ticketing system after completion. The conversational AI system 102 will keep track of which step in the checklist the user is on and allow the user to move to other steps, go back, or pause and resume a task while in the course of completing the checklist.

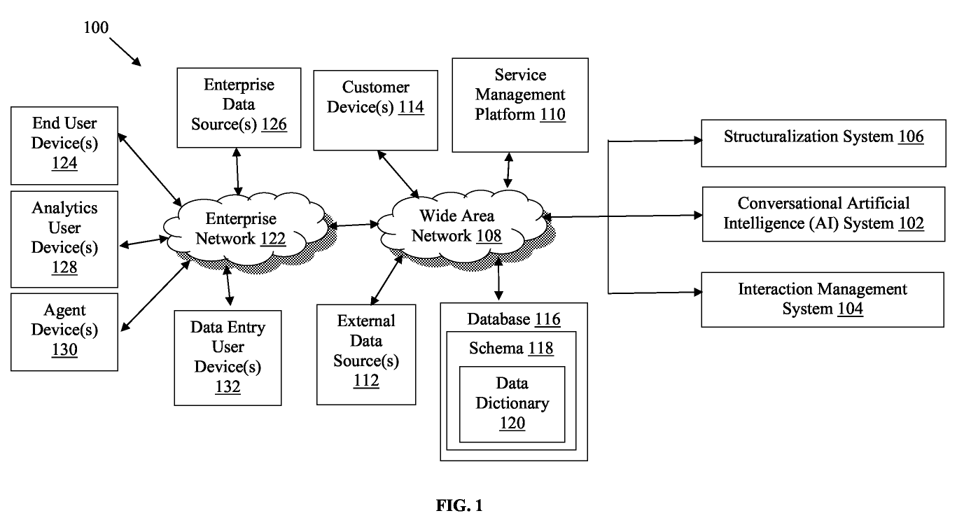

Referring now to FIG. 1, an exemplary network environment 100 is illustrated that includes a conversational AI system 102, interaction management system 104, and structuralization system 106 coupled, via wide area network (WAN) 108, to a service management platform 110, external data source(s) 112, customer device(s) 114, and a database 116 with a schema 118 and data dictionary 120, which are coupled via an enterprise network 122 to end user device(s) 124, enterprise data source(s) 126, analytics user device(s) 128, agent device(s) 130, and data entry user device(s) 132. The network environment 100 may include other network devices such as one or more routers, switches, firewall devices, and/or mid-servers, for example, which are known in the art and thus will not be described herein. This technology provides several advantages including methods, non-transitory computer readable media, and conversational AI systems that improve service task implementation and management by generating and delivering instructional content in conversationally manageable steps, monitoring execution of the steps, conversing with technicians to assist with execution of the steps, and logging and reporting step and task completion, among other advantages.

In one example, the conversational AI system 102 is a server or other device that is configured to integrate with the service management platform 110 to obtain service tickets that correspond with service tasks requiring execution or completion by a technician, for example. In other examples, the conversational AI system 102 is configured to communicate with the end user device(s) 124 to obtain queries relating to service tasks requiring completion. In yet other examples, both user queries and automated service ticket analysis can be supported by the conversational AI system 102. To generate and provide instructional content to facilitate the task completion, the conversational AI system 102 can ingest data from the enterprise data source(s) 126 and/or the external data source(s) 112 (e.g., webpage or other publicly available databases) and apply computer vision, large language, and/or other AI model(s) to the ingested data, as described and illustrate in more detail below.

While the end user device(s) 124, enterprise data source(s) 126, external data source(s) 112, service management platform 110, and conversational AI system 102 are disclosed in FIG. 1 as dedicated hardware devices, one or more of the end user device(s) 124, enterprise data source(s) 126, external data source(s) 112, service management platform 110, or conversational AI system 102 can also be implemented in software within one or more other devices in the network environment 100. As one example, the conversational AI system 102 can be implemented in software or as a virtual server hosted by the same hardware device as the service management platform 110. As another example, the conversational AI system 102, interaction management system 104, and/or structuralization system 106 can be implemented by the same hardware device. Many other permutations and types of implementations can also be used in other examples.

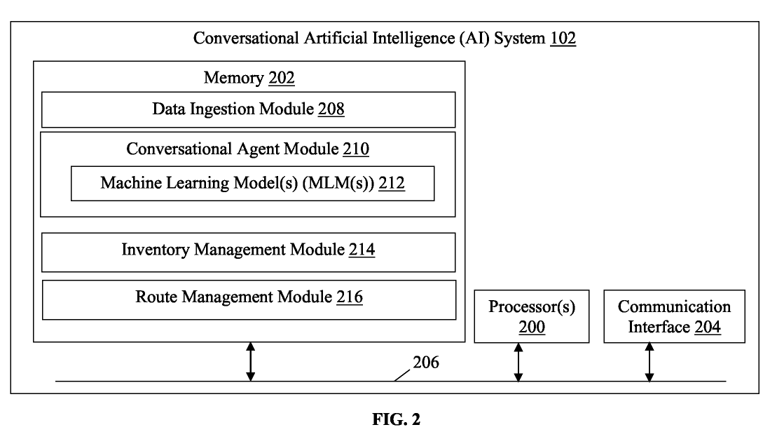

Referring to FIGS. 1-2, the conversational AI system 102 of the network environment 100 may perform any number of functions as described and illustrated by way of the examples herein. The conversational AI system 102 in this example includes processor(s) 200, memory 202, and a communication interface 204, which are coupled together by a bus 206, although the conversational AI system 102 can include other types or numbers of elements in other configurations.

The processor(s) 200 of the conversational AI system 102 may execute programmed instructions stored in the memory 202 of the conversational AI system 102 for any number of the functions described and illustrated herein. The processor(s) 200 may include one or more central processing units or with one or more processing cores, for example, although other types of processor(s) can also be used.

The memory 202 of the conversational AI system 102 stores these instructions for one or more aspects of the present technology as described and illustrated herein, although some or all of the instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 200, can be used for the memory 202.

Accordingly, the memory 202 can store one or more applications that can include computer executable instructions that, when executed by the conversational AI system 102, cause the conversational AI system 102 to perform actions, such as to transmit, receive, or otherwise process network messages and requests, for example, and to perform other actions described and illustrated below. The application(s) can be implemented as components of other applications, operating system extensions, and/or plugins, for example.

Further, the application(s) may be operative in a cloud-based computing environment. The application(s) can be executed within or as virtual machine(s) or virtual server(s) that may be managed in a cloud-based computing environment. Also, the application(s), and even the conversational AI system 102 itself, may be located in virtual server(s) running in a cloud-based computing environment rather than being tied to one or more specific physical network computing devices. Also, the application(s) may be running in one or more virtual machines (VMs) executing on the conversational AI system 102. Additionally, in one or more examples of this technology, virtual machine(s) running on the Conversational AI system 102 may be managed or supervised by a hypervisor.

In this particular example, the memory 202 includes a data ingestion module 208, a conversational agent module 210 with machine learning model(s) (MLM(s)) 212, an inventory management module 214, and a route management module 216, although other types or another number of modules or applications can be provided in other examples. The data ingestion module 208 is configured to obtain a corpus of information in the form of video data, audio data, user manuals, service manuals, website data, and/or product documentation, for example. The information can be obtained from the enterprise data source(s) 126 and/or the external data source(s) 112 and can relate to products that require servicing by mobile technicians, for example, although any other type of information can also be ingested.

The conversational agent module 210 provides an interface for interacting with users of the end user device(s) 124 (e.g., service technicians) in a conversational and step-wise manner. The conversational agent module 210 is configured to generate and provide graphical user interfaces (GUIs) and apply the MLM(s) 212 to the ingested data, which can be maintained in the memory 202 and/or in third-party database(s) coupled to the WAN (e.g., database 116), for example. Accordingly, the conversational agent module 210 is responsible for generating step-by-step instructional content using the MLM(s) 212, tracking execution or performance of the steps, and storing and reporting details of the execution of the steps, among other functions described and illustrated in more detail below. The conversational agent module 210 can operate in any modality including based on text, voice, gesture, video, images, and any other type of multimedia or other communication digital input.

The optional inventory management module 214 can be configured to link with an inventory database of the enterprise (e.g., one of the enterprise data source(s) 126) to determine the availability of parts to inform service task scheduling. For example, the inventory management module 214 can interface with the service management platform 110 to identify tickets relating to required services, automatically determine the parts that may be required to perform those services (e.g., using the MLM(s) 212), analyze availability and generate a list of those parts, and provide the parts list to a service technician users of the end user device(s) 124 so that the parts can be retrieved before the service technician initiates appointments to perform the service tasks. The inventory management module 214 is also described and illustrated in more detail below.

The optional route management module 216 can also be configured to interface with the service management platform 110 to obtain information regarding service tasks and generate schedules for service technicians based on the geographic locations of those tasks, inventory availability as determined by the inventory management module 214, predetermined arrival or completion time requirements, or any other input parameters. Accordingly, the route management module 216 can generate an optimal schedule for a service technician with respect to service tasks to be performed in a particular day, as explained in more detail below.

The communication interface 204 of the conversational AI system 102 operatively couples and communicates between the conversational AI system 102 and the service management platform 110 and/or the external data source(s) 112, which are coupled together at least in part by the WAN 108, although other types or another number of communication networks or systems with other types or numbers of connections or configurations to other devices or elements can also be used. By way of example only, the WAN 108 can use TCP/IP over Ethernet and industry-standard protocols, although other types or numbers of protocols or communication networks can be used. The WAN 108 can include the Internet and can employ any suitable interface mechanisms and network communication technologies including, for example, Ethernet-based Packet Data Networks (PDNs).

While the conversational AI system 102 is illustrated in this example as including a single device, the conversational AI system 102 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the conversational AI system 102. Additionally, one or more of the devices that together comprise the conversational AI system 102 in other examples can be standalone devices or integrated with one or more other devices or apparatuses.

As explained above, the service management platform 110 of the network environment 100 in this example can include a platform-as-a-service offering, such as ServiceNow^{TM}, or any other type of ticketing or service ticket management system, for example. Accordingly, the service management platform 110 can include one or more servers or other devices, each of which includes a processor, a memory, and a communication interface that are coupled together by a bus or other communication link (not illustrated), although other numbers or types of components could also be used.

The enterprise data source(s) 126 and external data source(s) 112 can be servers or other devices hosting database(s) storing information and data relating to products or other serviceable entities along with interactions between customers and agents. For example, the enterprise data source(s) 126 can be databases storing user manuals for products, audio customer-agent interactions, and/or transcribed customer-agent interactions and the external data source(s) 112 can be websites associated with those products and including how-to videos on aspects of servicing those products.

Accordingly, the external data source(s) 112 are external to the enterprise network 122 in this example but can be hosted by the enterprise or a third-party. Any other type of data and/or data source(s) can also be used in other examples. Thus, each of the enterprise data source(s) 126 and external data source(s) 112 include a processor, a memory, and a communication interface that are coupled together by a bus or other communication link (not illustrated), although other numbers or types of components could also be used.

The enterprise data source(s) 126 are coupled to the end user device(s) 124 via the enterprise network 122, which can employ any suitable interface mechanisms and network communication technologies including, for example, Ethernet-based Packet Data Networks (PDNs). While the enterprise data source(s) 126 are illustrated in FIG. 1 as an on-premises system coupled to the enterprise network 122, which may be hosted in a data center, for example, the enterprise data source(s) 126 can also be cloud-based or deployed elsewhere in the network environment 100 (e.g., coupled to the WAN 108) in other examples.

Each of the end user device(s) 124 of the network environment 100 in this example includes any type of computing device that can exchange network data, such as mobile, desktop, laptop, or tablet computing devices, virtual machines (including cloud-based computers), or the like. Each of the end user device(s) 124 includes a processor, a memory, and a communication interface, which are coupled together by a bus or other communication link (not illustrated), although other numbers or types of components could also be used.

Each of the end user device(s) 124 may run interface applications, such as standard web browsers or standalone client applications, which may provide an interface to communicate with the conversational AI system 102 via the enterprise network 122 and the WAN 108 in order to obtain instructional content and converse with the conversational agent module 210, for example. Each of the end user device(s) 124 may further include a display device, such as a display screen or touchscreen, or an input device, such as a keyboard or mouse, for example (not illustrated).

Although the exemplary network environment 100 with the end user device(s) 124, enterprise data source(s) 126, external data source(s) 112, service management platform 110, conversational AI system 102, enterprise network 122, and WAN 108 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the end user device(s) 124, enterprise data source(s) 126, external data source(s) 112, service management platform 110, or conversational AI system 102, for example, may be configured to operate as virtual instances on the same physical machine. In other words, one or more of the end user device(s) 124, enterprise data source(s) 126, external data source(s) 112, service management platform 110, or conversational AI system 102 may operate on the same physical device rather than as separate devices communicating through enterprise network and/or WAN. Additionally, there may be more or fewer end user devices, enterprise data sources, external data sources, service management platforms, or conversational AI systems, than illustrated in FIG. 1.

The examples of this technology may also be embodied as one or more non-transitory computer readable media having instructions stored thereon, such as in the memory 202, for one or more aspects of the present technology, as described and illustrated by way of the examples herein. The instructions in some examples include executable code that, when executed by one or more processors, such as the processor(s) 200, cause the processors to carry out steps necessary to implement the methods of the examples of this technology that are described and illustrated herein.

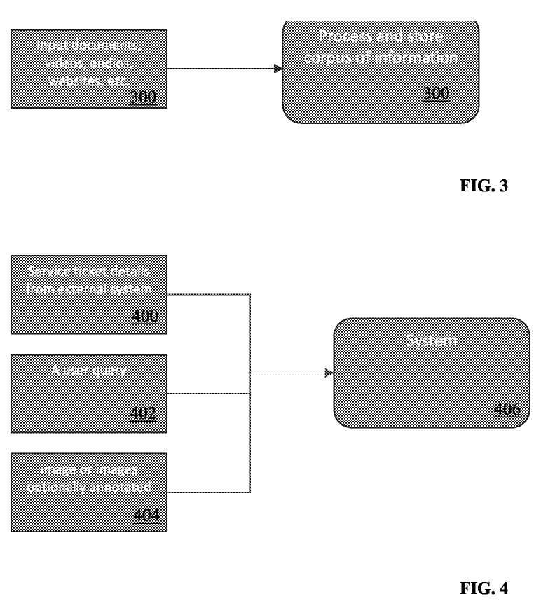

Referring to FIG. 3, a flowchart of an exemplary method for data ingestion is illustrated. In this example, the conversational AI system 102 in step 300 preprocesses a corpus of information from videos, audios, user manuals, service manuals, etc., which can be retrieved from the enterprise data source(s) 126 and/or external data source(s) 112. In step 302, the ingested data can be analyzed by the conversational AI system 102 (e.g., via optical character recognition (OCR)), normalized, reformatted, extrapolated, and/or stored (e.g., via embeddings in fixed-sized vectors) in a database (a vector database), and other preprocessing steps can also be performed in other examples.

Referring to FIG. 4, a flowchart of an exemplary method for receiving and processing an input or other query is illustrated. In this example, the conversational agent module 210 of the conversational AI system 102 can be initiated in any number of ways including, in step 400, as a result of service tickets and associated details obtained (e.g., periodically or in real-time) from an external system (e.g., the service management platform 110), in step 402, a query received from one of the end user device(s) 124, and/or, in step 404, image(s), optionally annotated, which can be part of a user query, and/or combinations of one or more of those inputs. The input(s) are provided to the conversational agent module 210 in step 406 in this example.

In some examples, the user query is in the form of a text or voice question posed to the voice agent module 210 of the conversational AI system 102 by a user of one of the end user device(s) 124 and regarding an image captured by the user and provided to the conversational AI system 102. In other examples, image(s) provided by the user can be annotated, which can provide more accurate results (e.g., instructional content), particularly when the unannotated part of the image is blurred or removed.

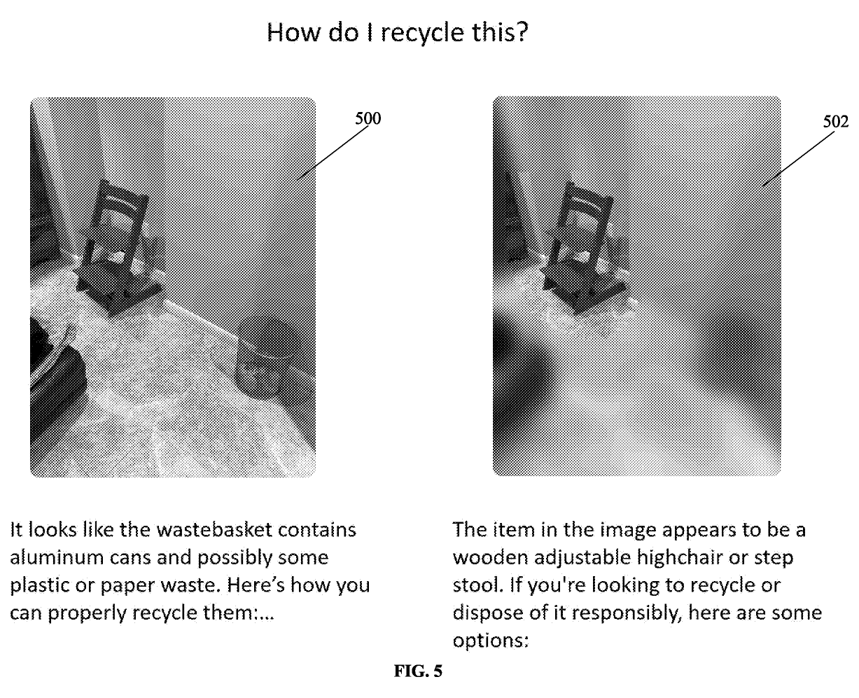

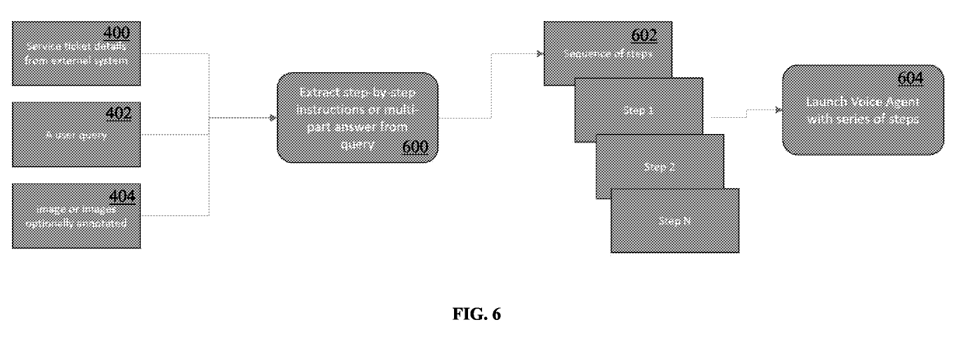

For example, referring to FIG. 5, exemplary user input annotated first and second images 500, 502 are illustrated. In some examples, when asking the MLM(s) 212 for information via the conversational agent module 210 about a particular part of an image, a simple annotation (e.g. drawing a circle around the object of interest) can be used. In other examples, results can be improved by removing or blurring the background of an annotation, which can allow the MLM(s) 212 to concentrate on the selected object or region of interest by removing any distraction that the MLM(s) 212 (e.g., a large language model (LLM)) might get from other objects in the view.

In the example of FIG. 5, the first image 500 is provided in a user query that asks: “How do I recycle this?” The first image is unannotated and contains a highchair and a wastebasket

containing aluminum cans and plastic or paper waste. In a second example illustrated in FIG. 5, a second image 502 is provided with the same user query, but the second image 502 is annotated by blurring of the image (including the wastebasket) surrounding the region of interest relating to the highchair. Thus, in this second example, the MLM(s) 212 can more easily determine that the query is how to recycle the highchair (instead of the contents of the wastebasket) and can provide more effective instructional content responsive to the query.

Referring now to FIG. 6, a flowchart of an exemplary method for generating step-by-step instructional content or a multi-part answer comprising smaller bits of information is illustrated. In this example, the conversational AI system 102 processes received input (i.e., a user query), in step 600, to extract step-by-step instructions or a multi-part answer comprising smaller bits of information. The instructional content and associated steps can be generated, in step 602 based on the extraction, and determined, respectively, based on the application of the MLM(s) 212 to the data ingested as explained in more detail above.

Each of the smaller bits of information is provided (e.g., via a GUI generated by the conversational agent module 210 and provided to a querying one of the end user device(s) 124), in step 604, so that the user can understand and optionally act on each bit of information and provide completion status for each bit of information separately. In some examples, the information provided via the instructional content, and/or information collected as feedback, is in the form of voice or audio, which can optionally be transcribed to text. The conversational agent module 210 maintains a procedure state vector identifying which steps have been completed and, in some examples can guide a user between steps, go back and forth, and/or collect images or voice confirmation of completion of each step.

Each of the steps includes one or more required structured fields and one or more validators. The structured fields can correspond to checklist items, for example, that a user is required to indicate as satisfied during performance of the procedure or tasks corresponding to the sequence of steps. The validators in some examples comprise a rule and a type of evidence associated with the rule that, when satisfied, permits a state transition (e.g., to a next step of the procedure).

For example, the validators can include an image, a video clip, a sensor measurement, a timestamp, or a location type of evidence. In some examples, the rule cannot be evaluated based on a manual input by the user. In one particular example described in more detail below, the rule can be that a tag on an electric meter during a lockout tagout (LOTO) step must include name and date details. The validator can then include an “image” type of evidence combined with the rule such that the conversational AI system 102 must analyze the image to determine the rule is satisfied (as compared to a user simply checking a box to indicate satisfaction of the rule). Any other types of rules, evidence, and validators can also be used in other examples.

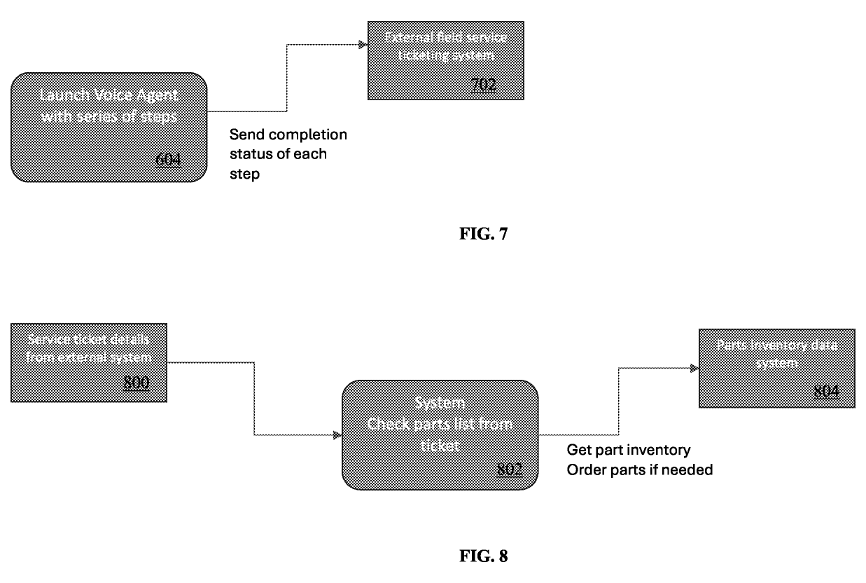

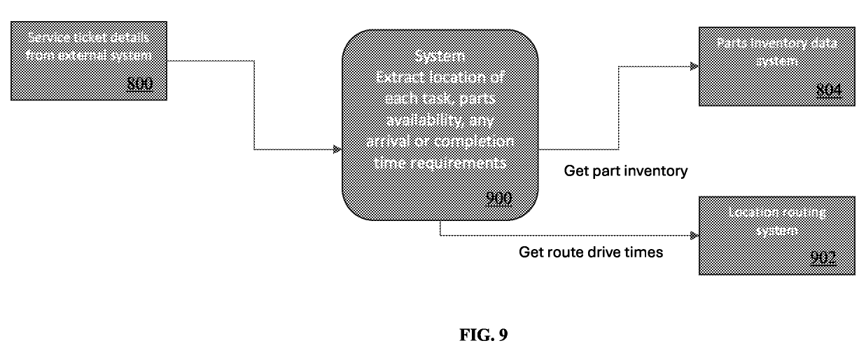

Referring to FIG. 7, a flowchart of an exemplary method for facilitating reporting of service task step completion is illustrated. In this example, the conversational AI system 102 saves and stores the status data of each of the small bits of information that collectively comprise the steps required to complete the task in response to the user query. In some examples, the status data can be sent, in step 702, to an originating system (e.g., the service management platform 110) and can include a completion status of steps of the generated step-by-step instructional content (e.g. a checklist completion status) and/or images that show completion status of each of the steps of the generated step-by-step instruction or checklist.

Referring to FIG. 8, a flowchart of an exemplary method for inventory management is illustrated. In this example, the conversational AI system 102 in step 800 obtains the user query in the form of service tickets obtained from the service management platform 110, although the user query can be obtained from other sources in other examples, as explained above. In response to the service ticket, in step 802, the conversational AI system 102 determines parts required to perform a service task corresponding to the service ticket (e.g., by applying the MLM(s) 212 to the ingested data). The conversational AI system 102 in step 804 can then check part inventory (e.g., from an inventory database or system communicably coupled to the enterprise network 122) and, if needed, automatically order parts (e.g., via an application programming interface (API) to a third-party part supplier system).

Referring to FIG. 9, a flowchart of an exemplary method for service ticket ingestion is illustrated. In this example, the conversational AI system 102 in step 800 obtains a collection of service tickets from the service management platform 110 as input queries. For each

of the service tickets, the conversational AI system 102 in step 900 determines service context data including the associated geographical location, required parts (e.g., as explained above with respect to step 804), and other metadata and parameters associated with the service tasks. Based on the service context data (parts availability, service geographic location, and predetermined arrival or completion time requirements), the conversational AI system 102 determines the scheduling, order, and/or timing of, and/or optimal route between, service locations in step 902.

In one exemplary use-case of the technology described and illustrated herein, a Heating, Ventilation, and Air Conditioning (HVAC) system at 123 Main Street is blowing hot air in the summer, so the customer submits a ticket to the HVAC service website (i.e., the service management platform 110 for the HVAC service). A service ticket is created and dispatched to a service technician. The service technician checks the ticket on an application of a mobile one of the end user device(s) 124 and sees that a part may be needed, which he obtains from the warehouse before departing to the service location. The mobile user device application is linked to the conversational AI system 102, which previously retrieved the ticket, determined the part that was needed (by applying the MLM(s) 212 to the service data ticket), and dispatched the ticket to the service technician via his mobile user device application.

The service technician then arrives at 123 Main Street and looks up the ticket on his mobile user device application. He is not sure what to do to address the blowing hot air of the HVAC system, so he asks his mobile user device application what the service procedure is, which is provided to the conversational AI system 102 in the form of a user input query to the conversational agent module 210. The conversational AI system 102 responds via the mobile user device application with a checklist of items to check.

The service technician must use his hands to perform the checklist, so he launches a walk-me-through-it utility, which opens a voice interface within the user mobile device application. The voice interface tells the service technician what to do at each step and clarifies his questions based on an interactive session with the conversational AI system 102 in which the conversational AI system 102 leverages an application of the MLM(s) 212 to ingested data (e.g., from the enterprise data source(s) 126) including user manuals regarding the HVAC system that include troubleshooting information.

The service technician performs the checklist items, taking and providing to the conversational AI system 102 a picture at the end of each step that shows that he has completed it. He finds the fault and repairs it by replacing a part, which the user mobile device application told him to bring with him to the service location. The service tech closes the ticket via the mobile user device application, which saves the status of the checklist along with the captured images back to the conversational AI system 102 and/or service management platform 110 to thereby retain a complete audit trail with evidence of performance and completion of each of the steps.

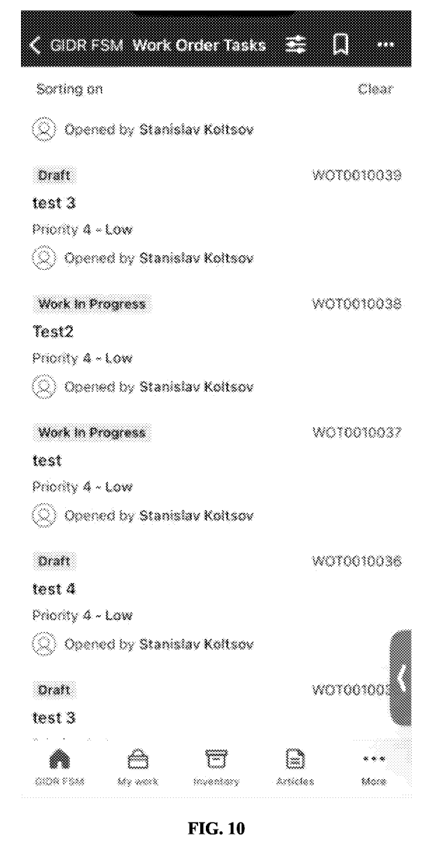

Referring to FIGS. 10-14, screenshots illustrating an exemplary work order task workflow are illustrated. In this example, connectivity to the conversational agent module 210 is provided by a native integration with an application provided by the service management platform 110 and hosted by the end user device(s) 124, which allows users (e.g., technicians) to trigger AI assistance directly from their work order task. Thus, a user can click a button to be redirected to a specific AI agent (e.g., the conversational agent module 210) assigned to a task type (e.g., a safety agent), passing all necessary context automatically. The AI agent then engages the technician in a conversational workflow, utilizing computer vision to verify physical requirements, such as analyzing a photo to confirm PPE compliance (hard hat, glasses) in real time, as will now be described.

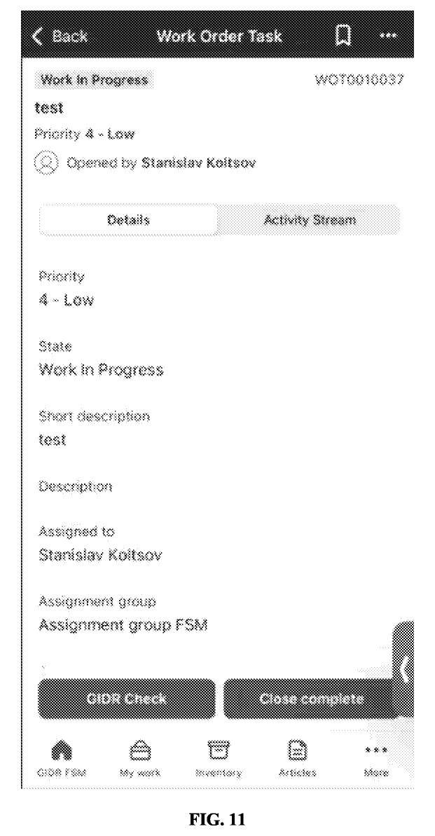

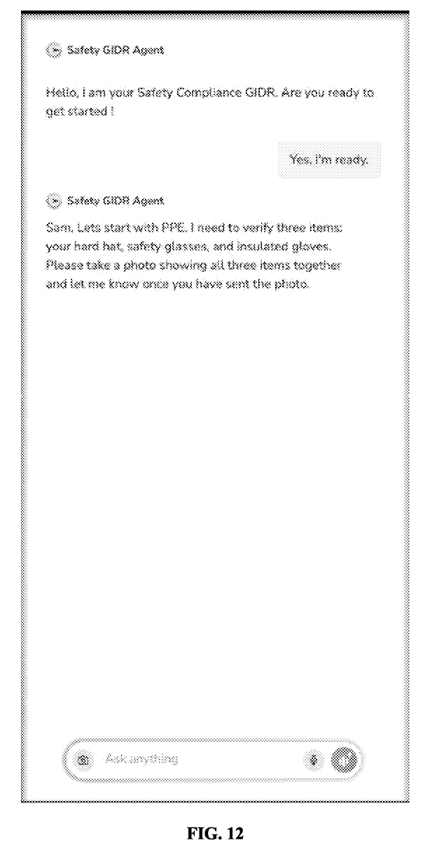

Referring specifically to FIG. 10, a user of one of the end user device(s) 124 may execute a native or web application to communicate with the conversational AI system 102 to initiate a session or interaction associated with a work order task. The tasks may be generated by the service management platform 110 and pushed to the application executed by the end user device 124 via an integration with the conversational AI system 102, for example. The user can select a task and begin the associated workflow via a button illustrated in FIG. 11. In this example, the conversational agent module 210 is configured for safety compliance and many interactions can be hands-free and via voice. The conversational agent module 210 asks the user in FIG. 12 to verify three items starting with taking and transmitting a photo.

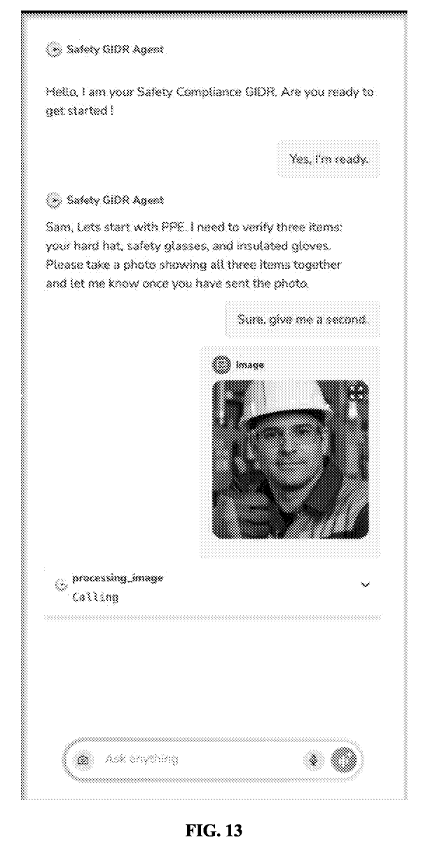

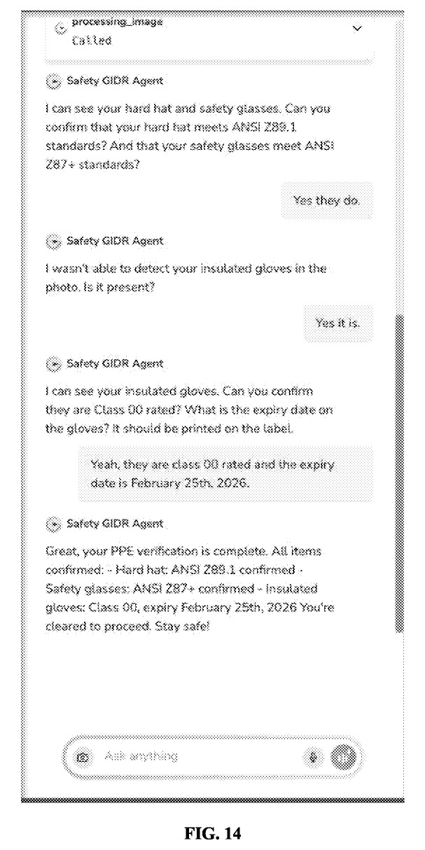

In FIG. 13, the user has captured an image with the end user device 124 and submitted the image to the conversational AI system 102 through the native or web application. In FIG. 14, the conversational agent module 210 requests that the user confirm the hard hat and glasses meet particular standards. The inquiry from the conversational agent module 210 can be generated following an automated analysis of the image captured and sent by the user. The user in this example confirms the standards are met and there is a further exchange regarding the gloves in which the user prompts the application to re-analyze the user’s image to identify the insulated gloves. The application then asks the user to confirm the gloves have a particular rating and provide the expiration date.

After the verification, the application confirms to the user that the user can proceed to perform a task and/or engage with another workflow/interaction/session. Each of the user’s answers and inputs are sent from the application to the conversational AI system 102 and logged to facilitate an audit trail that can be subsequently retrieved and analyzed to determine whether the user was compliant with the safety requirements prior to performing a task.

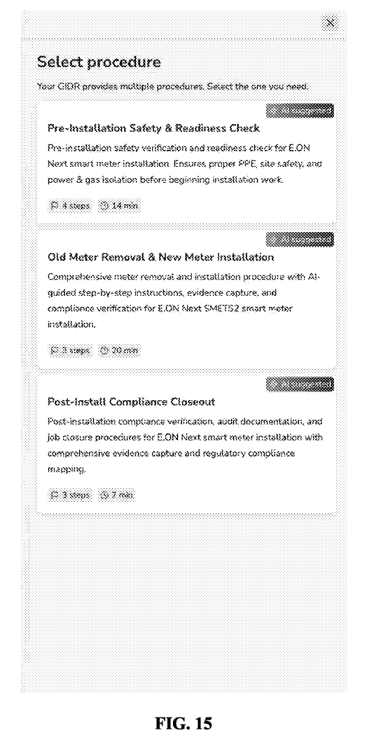

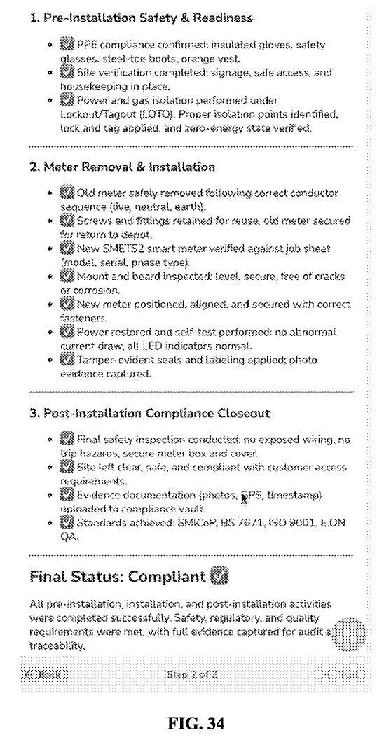

Referring now to FIGS. 15-34, screenshots illustrating an exemplary procedure workflow are illustrated. In this example, the application at the end user device 124 provides selectable procedures in FIG. 15 that correspond to a workflow. The procedures are equivalent to the tasks of the examples described above with reference to FIGS. 10-14. The procedures relate to the replacement of an electric meter and therefore correspond to a pre-installation safety and readiness check procedure, a removal and installation procedure, and a post-install compliance closeout procedure.

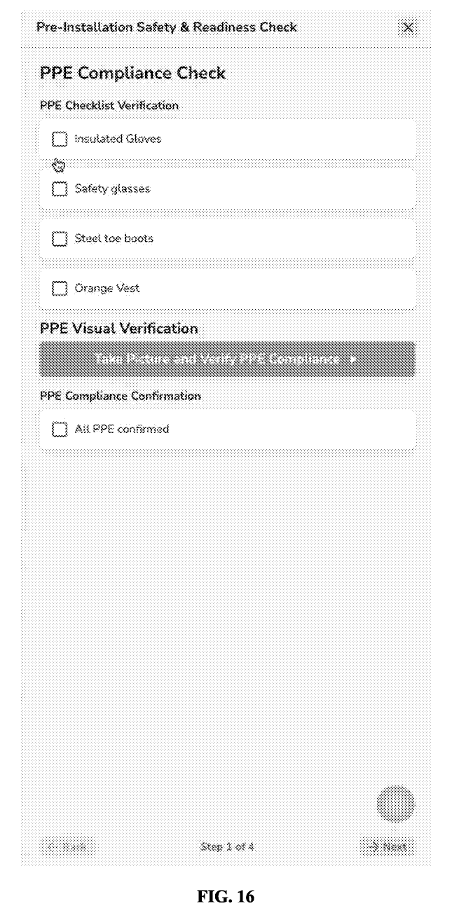

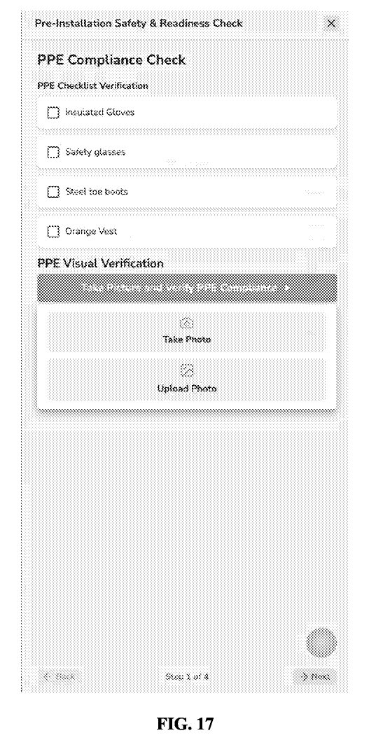

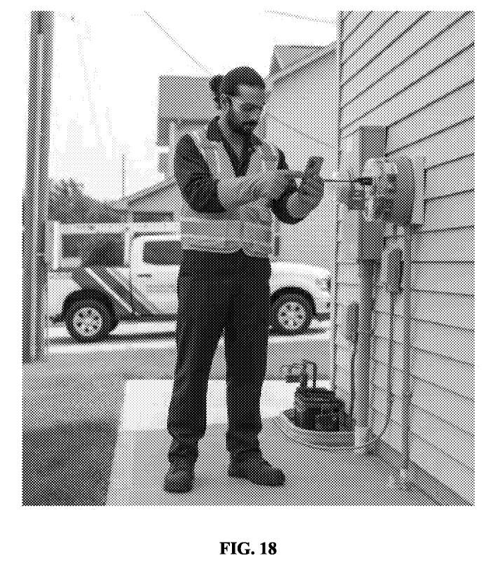

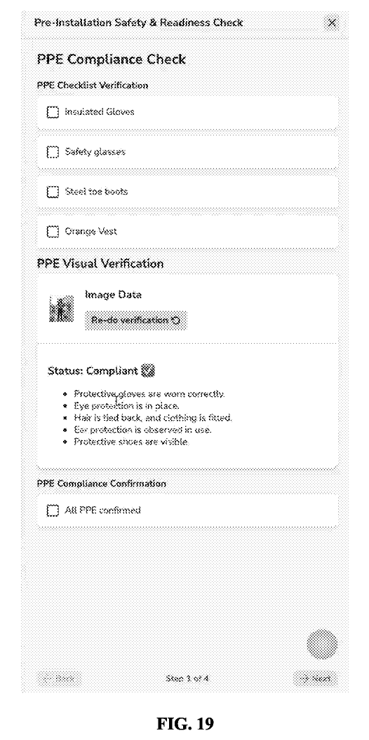

In FIG. 16, the user initiates the pre-installation procedure, which includes checklists and a requirement that a picture is obtained to verify PPE compliance. The user’s interactions with the checklist are transmitted to and logged by the conversational AI system 102. In FIG. 17, options for taking or uploading a photo are presented after user interaction with a button. A picture of the user, which is an electrical technician in this example, is illustrated in FIG. 18. In FIG. 19, the application determines that the user is compliant, and the compliance is also logged by the conversational AI system 102.

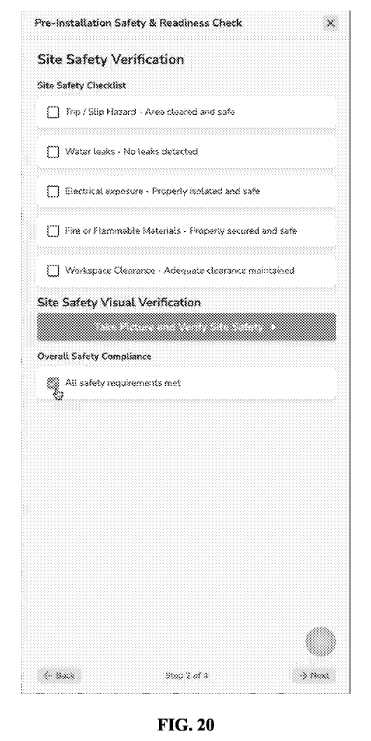

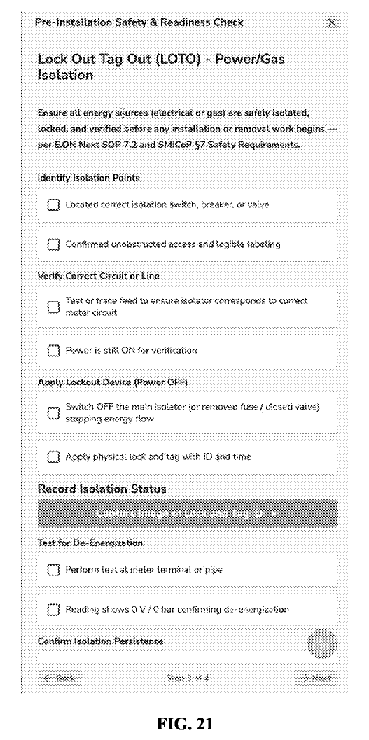

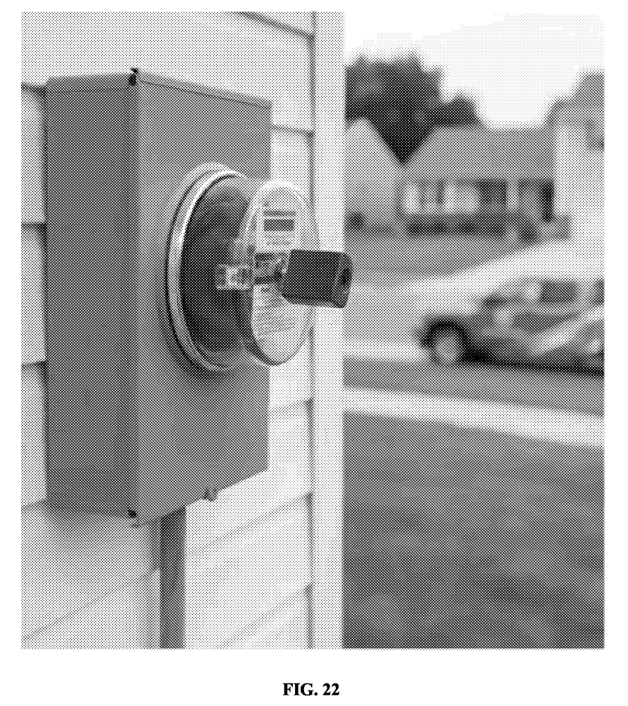

In FIG. 20, the application proceeds to a site safety verification portion of the pre-installation safety and readiness check procedure. The application again presents a checklist and facilitates communication of an image of the site, which the conversational AI system 102 automatically analyzes to determine that predefined, stored rules or requirements relating to site safety are satisfied. In FIG. 21, another portion of the pre-installation safety and readiness check procedure is illustrated relating to a lock out tag out (LOTO) process. Once again, the user is presented with a checklist and a requirement that an image of the lock and tag ID be captured. The image can be stored by the conversational AI system 102 as evidence of compliance for auditing purposes. FIG. 22 illustrates an example of such a submitted image.

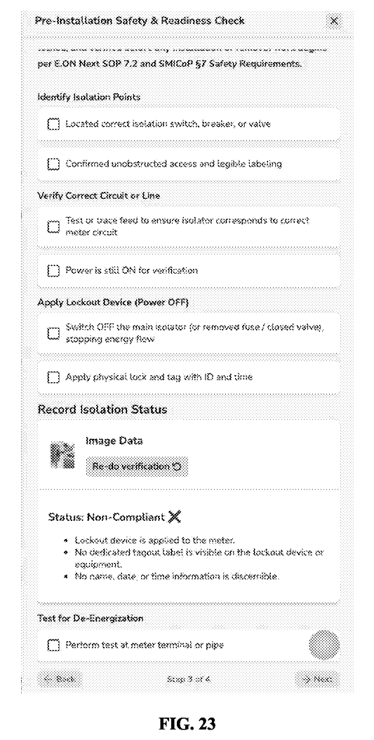

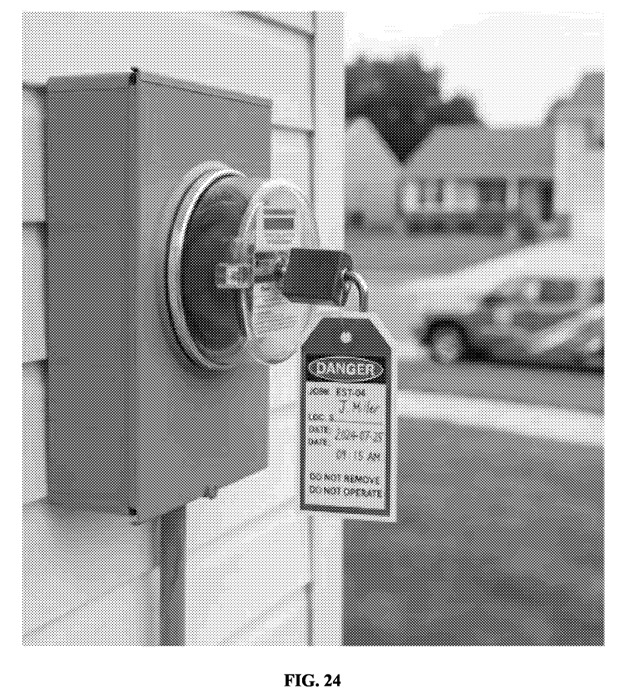

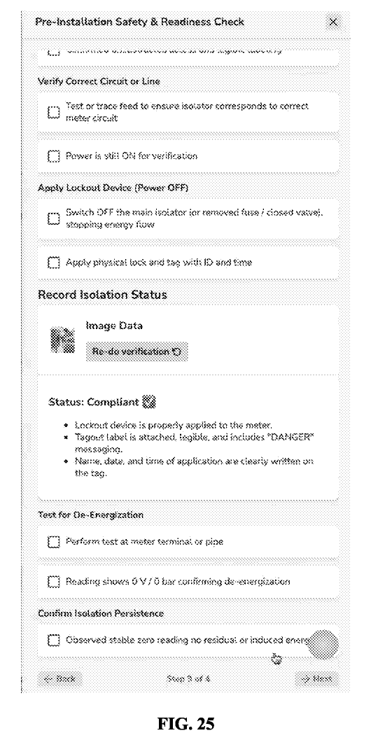

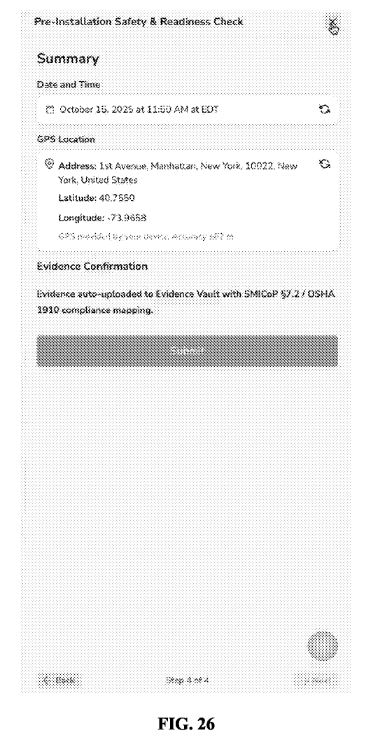

In the example, the conversational AI system 102 determines that the LOTO depicted in the image of FIG. 22 is deficient and communicates the same to the application in FIG. 23. The deficiency automatically identified by the conversational AI system 102 is presented in FIG. 23 (i.e., “No dedicated tagout label is visible on the lockout device or equipment. No name, date, or time information is discernable.”). Before the user can continue the procedure, the application requires that the user submit another captured image, an example of which is illustrated in FIG. 24. In FIG. 25, the conversational AI system 102 indicates the image depicts a compliant LOTO after automatically analyzing the subsequent image. FIG. 26 depicts a summary of the pre-installation safety and readiness check and allows the user to select a button to submit the summary information to the conversational AI system 102 for logging to facilitate future auditing.

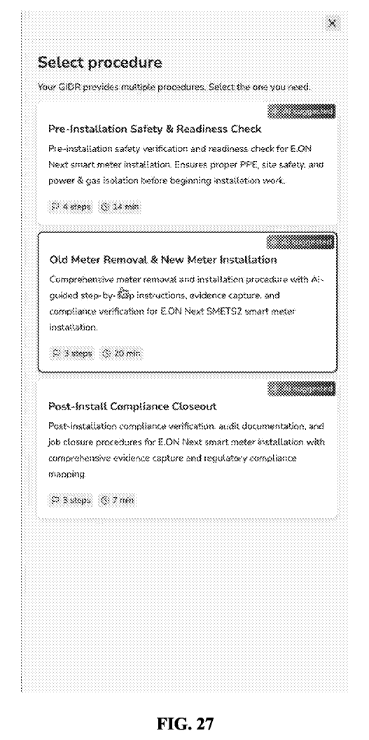

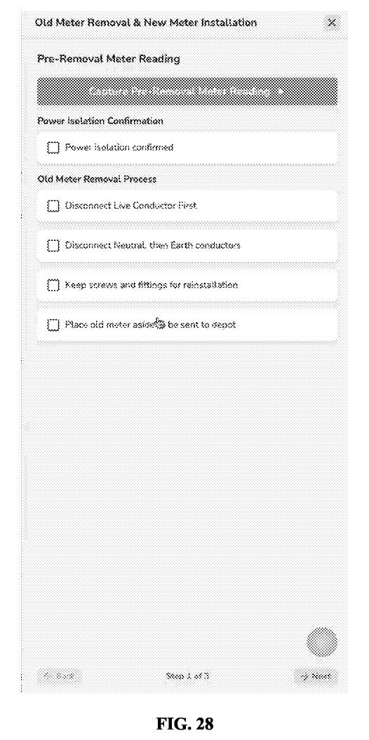

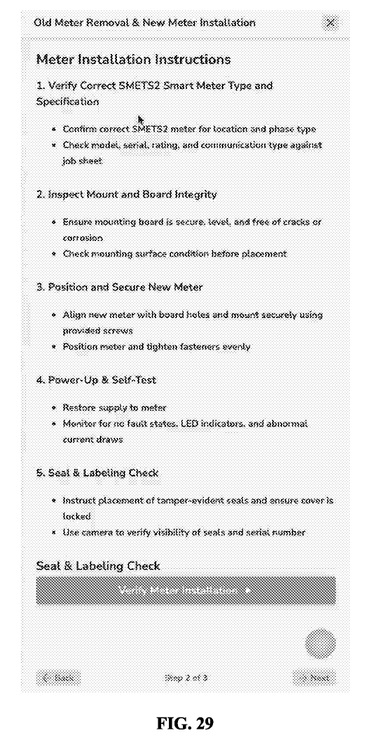

In FIG. 27, the user is brought back to the main procedure screen and selects the next procedure relating to old meter removal and new meter installation. Responsive to that selection, the application in FIG. 28 presents another checklist and a selectable button requesting capture and communication to the conversational AI system 102 of a pre-removal meter reading, again for logging and auditing purposes. In FIG. 29, meter installation instructions are presented via easily understandable and consumable steps. The meter installation instructions include reminders of checks and conformations that increase the likelihood of a successful meter installation.

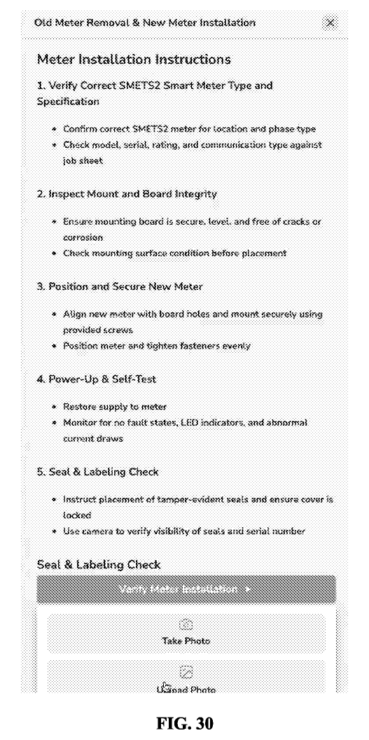

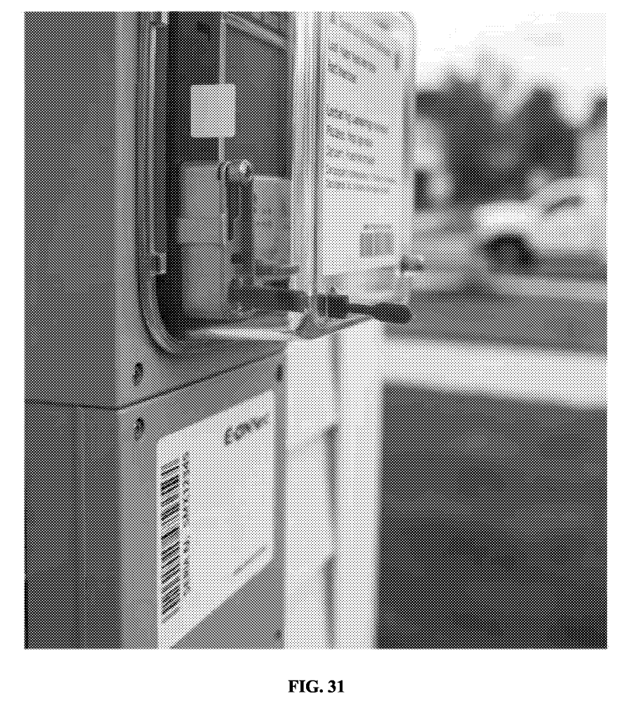

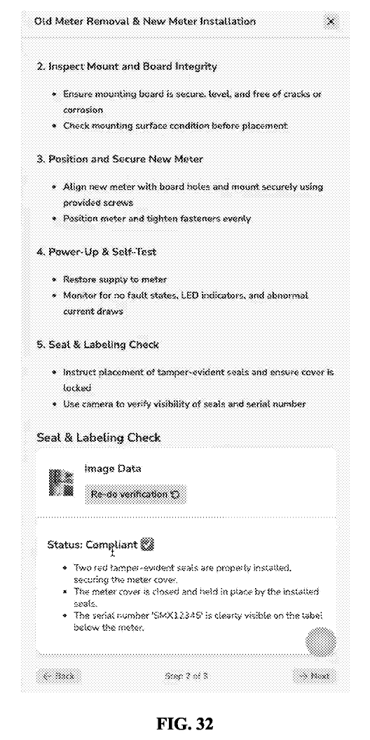

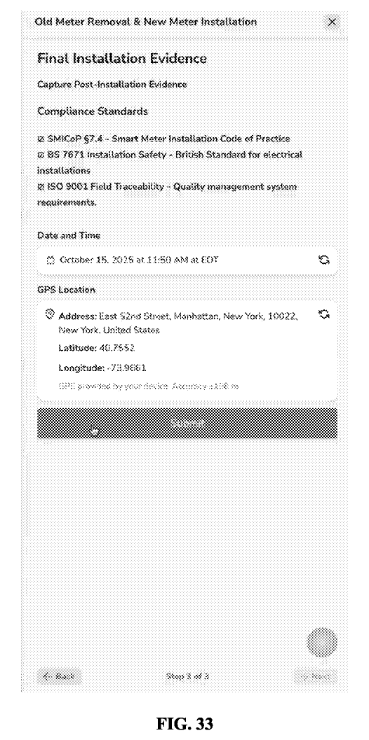

When the user has completed the steps, the user engages another button, as shown in FIG. 30, to submit an image of the installation meter for verification, logging, and auditing by the conversational AI system 102. An exemplary captured image is illustrated in FIG. 31. The conversational AI system 102 analyzes the image to determine whether predefined, stored requirements associated with the procedure are satisfied and reports a result of the analysis to the user via the application, as shown in FIG. 32. In a final installation screen illustrated in FIG. 33, the user can submit the compliance details to facilitate future confirmation that the procedure was completed in a successful and compliant manner. In this example, after completion of the third procedure relating to post-install compliance closeout (not shown), the application displays an indication of all of the checklist items that were successfully completed to inform the user that the status of the overall procedure is compliant.

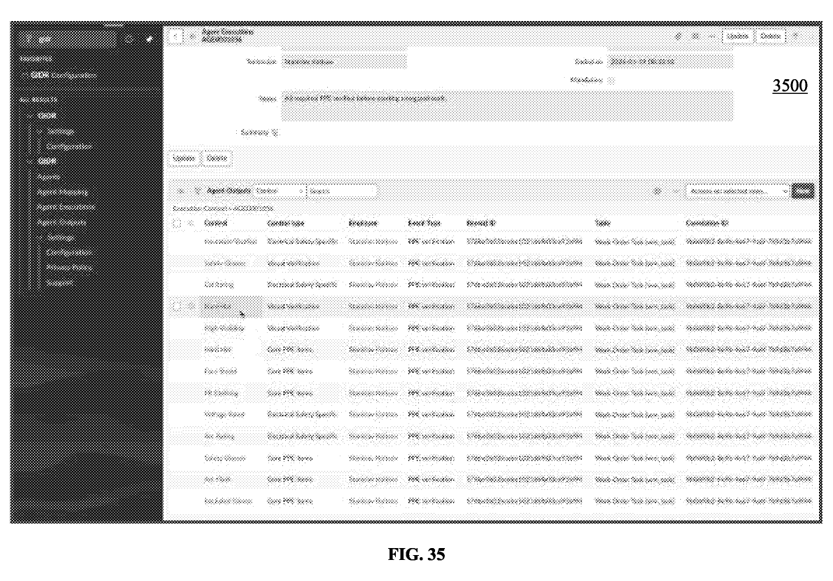

Referring to FIG. 35, a screenshot of an exemplary audit trail dashboard 3500 is illustrated. In this example, a detailed audit trail is provided for interactions or sessions via structured auditable execution records (e.g., maintained by a database at the service management platform 110), which links the specific work order tasks or procedures to the verification results obtained by the conversational agent module 210 for full traceability. Administrators (e.g., users of the analytics user device(s) 128) can inspect specific technical parameters (ANSI Z89.1 for head protection and ANSI Z87+ for eye protection) for deep-dive analysis. Since the conversational agent module 210 can break down high-level checks into individual line items (e.g., hard hat, face shield, fire retardant clothing), every specific safety requirement can be tracked, validated, and logged independently.

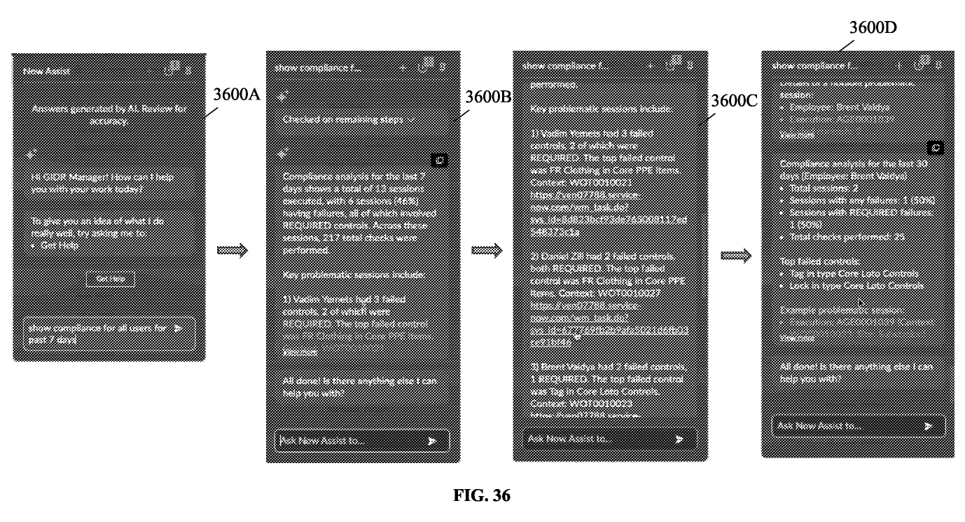

Referring to FIG. 36, screenshots of exemplary compliance interfaces 3600A-D are illustrated. The compliance interfaces 3600A-D can be generated by the conversational AI system 102 and provided to the analytics user device(s) 128, for example. In the compliance interface 3600A, the user submits a request for compliance for all users for the past seven days. The conversational AI system 102 receives that request in this example and, in the compliance interface 3600B, provides a response identifying the number of sessions with failures and flagging key problematic sessions in which particular controls were failed. Additional details regarding the key problematic sessions are illustrated in the compliance interface 3600C along with links associated with the key problematic sessions.

Selection of a link prompts the conversational AI system 102 to generate the compliance interface 3600D, which provides information regarding a particular user/employee associated with one of the key problematic sessions. The compliance interface 3600D indicates that the employee had a failed session and identifies the controls that were failed. With this information, the administrator or analytics user can initiate an action to mitigate future failures, such as targeting the employee with responsive training.

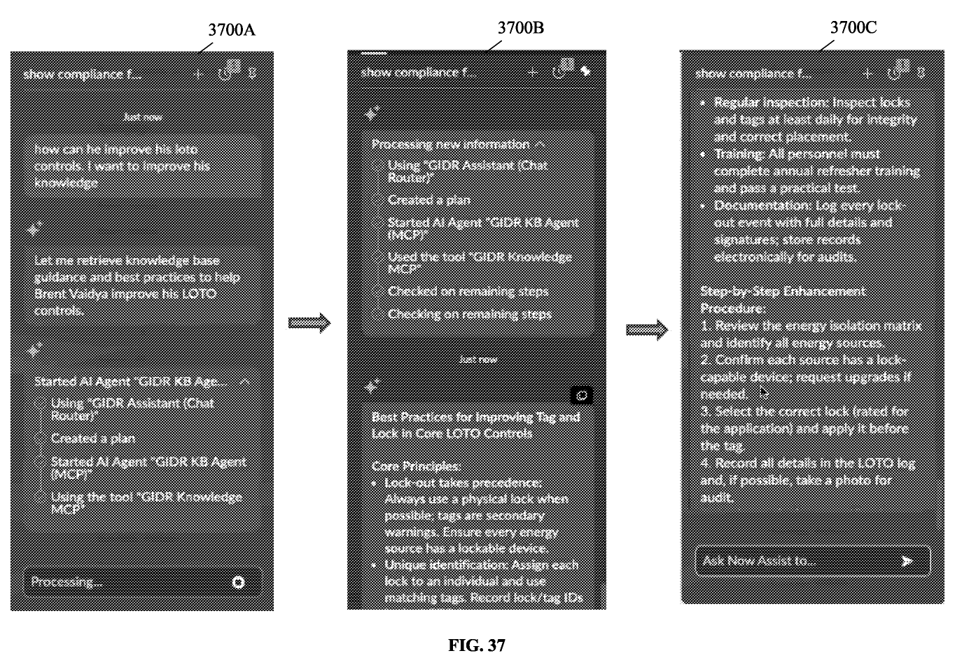

For example, referring to FIG. 37, screenshots of exemplary training interfaces 3700A-C are illustrated, which can also be generated by the conversational AI system 102 and provided to the analytics user device(s) 128, for example. In the training interface 3700A, the administrator user asks how he can improve the controls for an employee associated with key problematic session(s). In the training interface 3700B, the conversational AI system 102 generates and displays best practices for improving the tag and lock in control procedures indicated as failed in the stored audit/compliance information. In the training interface 3700C, the conversational AI system 102 generates and displays a step-by-step procedure for the employee to train the employee to mitigate risk and reduce failed sessions.

Thus, with this technology, administrator or managers can bypass complex report builders and simply ask questions in plain English, such as "show compliance for all users for past 7 days," to retrieve performance data. The conversational AI system 102 automatically analyzes session data to surface "key problematic sessions," identifying specific technicians with high failure rates and pinpointing the exact controls they failed (e.g., PPE verification or lockout/tagout tags). The conversational AI system 102 provides granular breakdowns per employee, summarizing total sessions, failure percentages, and specific compliance gaps over a requested period. Every insight includes direct, clickable URLs to the relevant work order tasks and system IDs, allowing managers to navigate from the chat interface to the specific record for investigation.

Accordingly, managers can pivot from identifying a performance gap to requesting specific solutions by asking the conversational AI system 102 natural questions like "how can he improve his LOTO controls?". The conversational AI system 102 in this example returns detailed, formatted guidance—such as "Core Principles," "Regular Inspection" requirements, and "Step-by-Step Enhancement Procedures” ensuring the advice is practically applicable. This capability allows managers to bridge the gap between audit findings and employee training, delivering specific safety standards (e.g., energy isolation matrices) directly within the conversational interface.

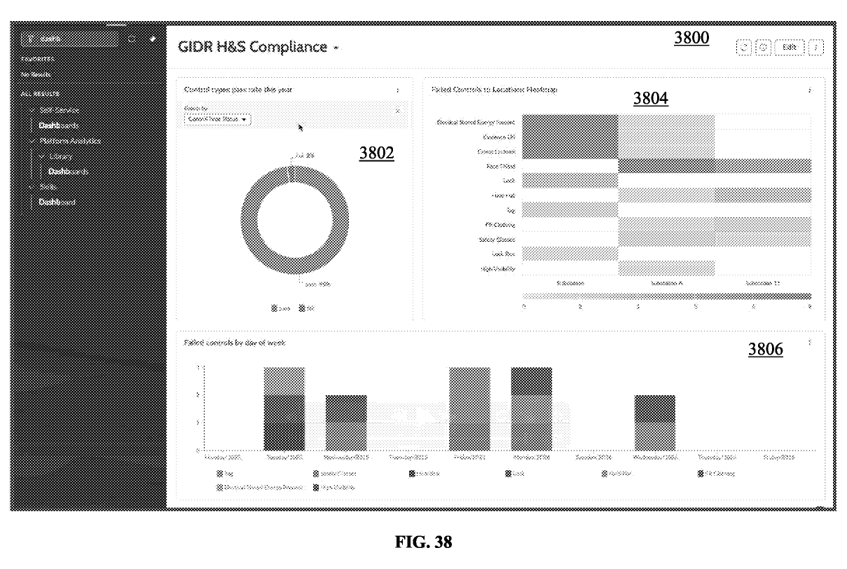

Referring to FIG. 38, a screenshot of an exemplary compliance dashboard 3800 is illustrated, which can also be generated by the conversational AI system 102 and provided to the analytics user device(s) 128, for example. The compliance dashboard 3800 can be generated or populated based on data obtained by the conversational AI system 102 during monitoring of interactions with the AI chatbot system 208. In this example, the compliance dashboard 3800 provides a high-level view of organizational safety health, featuring metrics like the "Control Types Pass Rate" doughnut chart 3802 (e.g., 98% Pass vs. 2% Fail). Managers can utilize the "Failed Controls to Locations” heatmap 3804 to correlate specific safety gaps, identifying training needs per location. The "Failed controls by day of week" visualization 3806 breaks down non-compliance events over time, allowing managers to identify patterns in safety behavior across different shifts or days of the week. Other analytics can also be provided via the compliance dashboard 3800 in other examples.

Accordingly, as described and illustrated by way of the examples herein, this technology advantageously facilitates more efficient execution of service tasks by leveraging MLM(s) 212 and a corpus of relevant data to generate instructional content in the form of step-by-step instructions. This technology also provides part inventory management, optimized service routing, and improved reporting regarding completed service tasks.

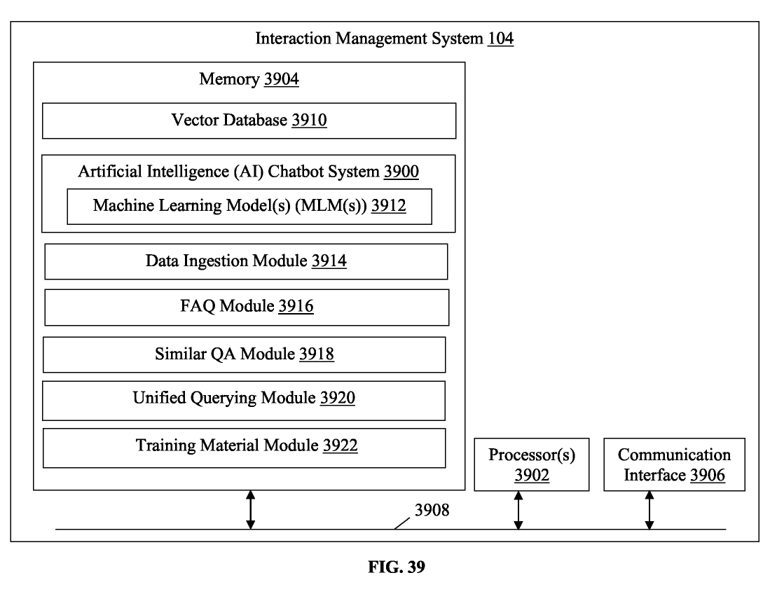

Referring back to FIG. 1 and FIG. 39, other examples of this technology will now be described with reference to the interaction management system 104. Business process outsourcing (BPO) entities, as well as other large enterprises that have internal support groups, often provide helpdesk services for end customers, to help solve customer problems. These helpdesk services are often called call or contact centers and are staffed by agents. Due to short tenures and low retention rates, for example, training new call agents is a high priority. Enterprises employ many techniques for training and assisting call agents with service tasks, including generation of training materials, providing frequently asked questions (FAQs) of trending customer calls, and analyzing customer calls to provide feedback to agents and managers.

One area of particular interest with BPO operators is generation of highly relevant and timely FAQs and their answers, as well as keeping their training content up to date and relevant. Current processes for FAQ creation and updating are generally manual and time-consuming, leading to inaccuracies and inefficiencies. Additionally, current automated trending topic and FAQ analysis systems provide low quality output and are generally ineffective to support call agents in efficiently responding to end customer queriers.

In some examples, the technology disclosed herein relates to systems and methods for managing frequently asked questions (FAQs) and answers in a service management domain environment. The interaction management system 104 of this technology provides semi or fully automated creation and maintenance of high quality and timely FAQs or other trending topics from product documentation and/or enterprise communications including customer call recordings, service tickets, chats, e-mails, etc. This technology also captures and manages FAQs generated by agents via interaction with the AI chatbot system 3900, for example, by automatically creating similar questions and answers.

As explained above, in the exemplary network environment 100 the interaction management system 104 is coupled, via the WAN 108, to the service management platform 110, customer device(s) 114, and enterprise network 1122, which is coupled to the agent device(s) 130 and enterprise data source(s) 126. This technology provides several advantages including methods, non-transitory computer readable media, and interaction management systems that improve automated contact center analysis systems to generate more effective FAQ answers, trending topics, and training materials, for example, to facilitate improved real-time customer interactions by call agents, among other advantages.

In one example, the interaction management system 104 is a server or other device that is configured to integrate with the enterprise network 122 to obtain enterprise data maintained by the enterprise data source(s) 126 and relating to customer interactions that are managed by users (e.g., call agents) of the agent device(s) 130 and analyze the obtained enterprise data for FAQ, trending topic, and training material generation, for example. The interaction management system 104 can also be configured to integrate with the service management platform 110, which can be a ticketing system capable of receiving inquiries from the customer device(s) 114 and providing those inquiries to the interaction management system 104. The customer device(s) 114 can also interact with the agent device(s) 130 over the WAN 108 and enterprise network 122 to provide questions and receive answers, such as for sales, billing, or product delivery support, for example.

While the agent device(s) 130, enterprise data source(s) 126, customer device(s) 114, service management platform 110, and interaction management system 104 are disclosed in FIG. 1 as dedicated hardware devices, one or more of the agent device(s) 130, enterprise data source(s) 126, customer device(s) 114, service management platform 110, or interaction management system 104 can also be implemented in software within one or more other devices in the network environment 100. As one example, the interaction management system 104 can be implemented in software or as a virtual server hosted by the same hardware device as the service management platform 110, and many other permutations and types of implementations can also be used in other examples.

The interaction management system 104 of the network environment 100 may perform any number of functions as described and illustrated by way of the examples herein. The interaction management system 104 in this example includes processor(s) 3902, memory 3904, and a communication interface 3906, which are coupled together by a bus 3908, although the interaction management system 104 can include other types or numbers of elements in other configurations.

The processor(s) 3902 of the interaction management system may execute programmed instructions stored in the memory 3904 of the interaction management system for any number of the functions described and illustrated herein. The processor(s) 3902 may include one or more central processing units or with one or more processing cores, for example, although other types of processor(s) can also be used.

The memory 3904 of the interaction management system stores these instructions for one or more aspects of the present technology as described and illustrated herein, although some or all of the instructions could be stored elsewhere. A variety of different types of memory storage devices, such as RAM, ROM, hard disk, solid state drives, flash memory, or other computer readable medium which is read from and written to by a magnetic, optical, or other reading and writing system that is coupled to the processor(s), can be used for the memory 3904.

Accordingly, the memory 3904 can store one or more applications that can include computer executable instructions that, when executed by the interaction management system 104, cause the interaction management system 104 to perform actions, such as to transmit, receive, or otherwise process network messages and requests, for example, and to perform other actions described and illustrated below. The application(s) can be implemented as components of other applications, operating system extensions, and/or plugins, for example.

Further, the application(s) may be operative in a cloud-based computing environment. The application(s) can be executed within or as virtual machine(s) or virtual server(s) that may be managed in a cloud-based computing environment. Also, the application(s), and even the interaction management system 104 itself, may be located in virtual server(s) running in a cloud-based computing environment rather than being tied to one or more specific physical network computing devices. Also, the application(s) may be running in one or more virtual machines (VMs) executing on the interaction management system 104. Additionally, in one or more examples of this technology, virtual machine(s) running on the Interaction management system 104 may be managed or supervised by a hypervisor.

In this particular example, the memory 3904 includes a vector database 3910 and the artificial intelligence (AI) chatbot system 3900, which includes MLM(s) 3912 (e.g., (LLM(s)), a data ingestion module 3914, an FAQ module 3916, a similar QA module 3918, a unified querying module 3920, and a training material module 3922, although other types or another number of modules or applications can be provided in other examples. The data ingestion module 3914 is configured to obtain a corpus of information in the form of audio data, call logs and/or transcripts, and/or product documentation, for example. The information can be obtained from the enterprise data source(s) 126 and can relate to products for which questions from the customer device(s) 114 may be received and serviced by users of the agent device(s) 130, as well as contextual data relating to the interactions between users of those agent device(s) 130 and customer device(s) 114.

In some examples, the interaction management system 104 embeds the ingested data for storage in the vector database 3910 and subsequent use by the MLM(s) 3912, as described and illustrated in more detail below. While the vector database 3910 is disclosed in FIG. 39 as stored by the memory 3904 of the interaction management system 104, in other examples the vector database 3910 can be hosted by a third-party device coupled to the WAN 108 (e.g., a cloud storage device).

The FAQ module 3916 in this example is configured to automatically create initial FAQs from product documentation, for example, which is ingested by the data ingestion module 3914. The initial FAQs and/or associated topics can be created using the MLM(s) 3912. The FAQ module 3916 also automatically updates FAQs from enterprise communications including call recordings, service tickets, chats, and/or e-mails, which are also ingested by the data ingestion module 3914. Thus, the FAQ module 3916 can maintain a trending topic list within which particular FAQs (e.g., highly rated FAQs) are available to call agents to facilitate more effective and prompt response to questions from customers.

The similar QA module 3918 captures and manages questions generated by agents. The AI chatbot system 3900 can be configured to interact with the agent device(s) 130 to provide answers to questions that can be the same as, or reformatted versions of, questions posted by customers to agents using the customer device(s) 114. To provide the answers, the similar QA module 3918 can apply the MLM(s) 3912 to historical enterprise data retrieved by the data ingestion module 3914, such as historical agent-customer interaction transcriptions, for example.

The unified querying module 3920 provides synthetic answers and relevant or similar questions, topics, and answers from both the FAQ module 3916 and the similar QA module 3918. Thus, the unified querying module 3920 advantageously considers both agent-generated and customer-generated questions and associated answers in its application of the MLM(s) 3912 to generate and provide synthetic answers to agents via the agent device(s) 130 to facilitate more effective servicing of customer inquiries.

The training material module 3922 is configured to automatically generate training materials from questions and topics to train and update call agents. For example, the training material module 3922 can be configured to generate incorrect answers to questions, as well as retrieved corrected answers to the same questions, to facilitate testing and training of agents, as will be explained in more detail below.

The communication interface 3906 of the interaction management system 104 operatively couples and communicates between the interaction management system 104 and the service management platform 110, the customer device(s) 114, the agent device(s) 130, and/or the enterprise data source(s) 126, which are coupled together at least in part by the WAN 108 and the enterprise network 122, although other types or another number of communication networks or systems with other types or numbers of connections or configurations to other devices or elements can also be used.

While the interaction management system 104 is illustrated in this example as including a single device, the interaction management system 104 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the interaction management system 104. Additionally, one or more of the devices that together comprise the interaction management system 104 in other examples can be standalone devices or integrated with one or more other devices or apparatuses.

Each of the agent device(s) 130 and customer device(s) 114 of the network environment 100 in this example includes any type of computing device that can exchange network data, such as mobile, desktop, laptop, or tablet computing devices, virtual machines (including cloud-based computers), or the like. Each of the agent device(s) 130 and customer device(s) 114 includes a processor, a memory, and a communication interface, which are coupled together by a bus or other communication link (not illustrated), although other numbers or types of components could also be used.

Each of the agent device(s) 130 and customer device(s) 114 may run interface applications, such as standard web browsers or standalone client applications, which may provide an interface to communicate with the interaction management system 104 and/or service management platform 110 via the enterprise network and the WAN, respectively, in order to submit tickets, ask customer service questions, and provide responsive answers, for example. Each of the agent device(s) 130 and customer device(s) 114 may further include a display device, such as a display screen or touchscreen, or an input device, such as a keyboard or mouse, for example (not illustrated).

Although the exemplary network environment 100 with the agent device(s) 130, enterprise data source(s) 126, service management platform 110, customer device(s) 114, interaction management system 104, enterprise network 122, and WAN 108 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the agent device(s) 130, enterprise data source(s) 126, service management platform 110, customer device(s) 114, or interaction management system 104, for example, may be configured to operate as virtual instances on the same physical machine. In other words, one or more of the agent device(s) 130, enterprise data source(s) 126, service management platform 110, customer device(s) 114, or interaction management system 104 may operate on the same physical device rather than as separate devices communicating through enterprise network 122 and/or WAN 108. Additionally, there may be more or fewer agent devices, enterprise data sources, service management platforms, customer devices, and/or interaction management systems, than illustrated in FIG. 1.

The examples of this technology may also be embodied as one or more non-transitory computer readable media having instructions stored thereon, such as in the memory 3904, for one or more aspects of the present technology, as described and illustrated by way of the examples herein. The instructions in some examples include executable code that, when executed by one or more processors, such as the processor(s) 3902, cause the processors to carry out steps necessary to implement the methods of the examples of this technology that are described and illustrated herein.

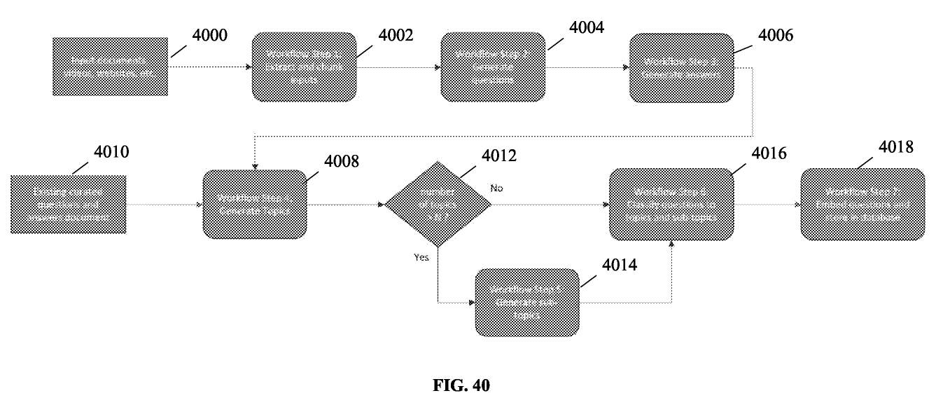

Referring to FIG. 40, a flowchart of an exemplary method for initial FAQ creation is illustrated. In this example, the interaction management system 104 in step 4000 obtains information from the enterprise data source(s) 126, such as stored historical agent-customer interactions in the form of audio or text transcriptions, for example. Then, in step 4002, the interaction management system extracts content from the ingested unstructured data and splits the extracted content into chunks (e.g., page level) to facilitate downstream processes (e.g., on a subset of a document), as explained in more detail below. The ingested data can also be analyzed (e.g., via OCR), normalized, reformatted, extrapolated, and/or stored (e.g., via embeddings in fixed-sized vectors) in the vector database 3910, and other preprocessing steps can also be performed in other examples.

In step 4004, the interaction management system 104 generates or identifies questions from each chunk of content identified in step 4002. To generate questions, the interaction management system 104 can apply one of the MLM(s) 3912 to the extracted and split chunks of content.

In step 4006, the interaction management system 104 generates or identifies answers to the questions generated in step 4004. The interaction management system 104 can generate the answers using the extracted and split chunks of data and one of the MLM(s) 3912. In other examples, the interaction management system 104 can perform a retrieval-augmented generation (RAG) step on the ingested data corpus to generate the answers to the questions.

In step 4008, the interaction management system 104 generates topics by applying one of the MLM(s) 3912 to the questions generated in step 4004. In other examples, the interaction management system 104 can obtain, in an optional step 4010, a curated list of questions and answers to which one of the MLM(s) 3912 is applied in step 4008 to generate the topics in place of, or in combination with, steps 4000-4006.

The interaction management system 104 then determines whether the number of topics exceeds a predefined topic threshold number, although other types of conditions can be tested in step 4012. If the interaction management system 104 determines that the number of topics exceeds the topic threshold number, then the Yes branch is taken to step 4014. In step 4014, the interaction management system 104 generates sub-topics by effectively implementing a second level or iteration of topic generation as explained in step 4008 to reduce the number of topics to a smaller number (e.g., ten). The original topics list generated in step 4008 then becomes a sub-topics list. Steps 4008 and 4012-414 can be performed any number of times in accordance with a desired predetermined topics threshold number. After generating the sub-topics or if the No branch is taken from step 4012, then the interaction management system 104 proceeds to step 4016.

In step 4016, the interaction management system 104 classifies the questions generated in step 4004 into the topics generated in step 4008 and/or the sub-topics generated in step 4014. The interaction management system 104 optionally applies one of the MLM(s) 3912 to classify the questions in step 4016.

In step 4018, the interaction management system 104 then embeds questions and stores the embedded questions in the vector database 3910 along with metadata including the associated answers, topics, sub-topics, date, time, agent identification, and/or customer, for example. Accordingly, in one example, generated questions may be “How do I make a payment?” and “How do I cancel a payment?” and a generated topic may be “Billing,” although any other types of questions and topics can be generated in other examples.

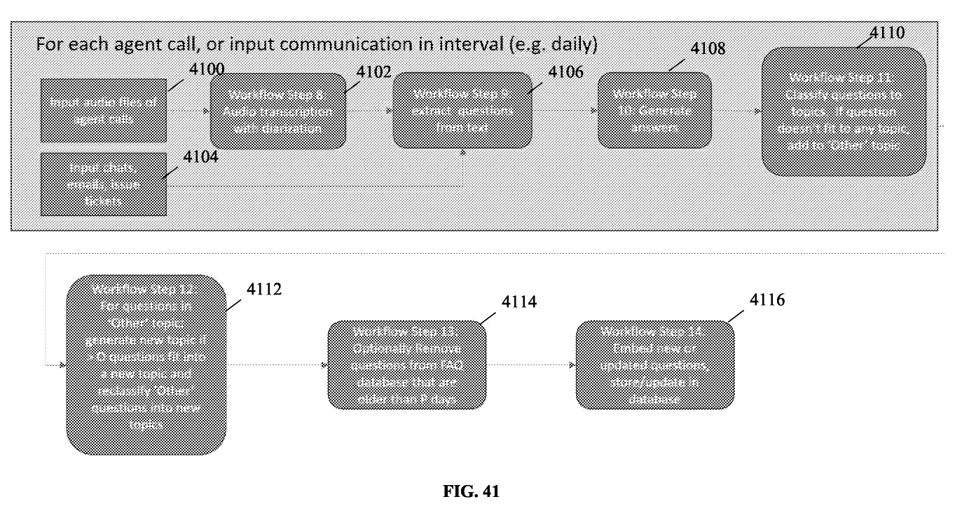

Referring to FIG. 41, a flowchart of an exemplary method of FAQ updating is illustrated. In this example, the interaction management system 104 implements the method of FIG. 40 at startup and then the method of FIG. 41 to maintain the topics, which begins with a periodic (e.g., daily) data ingestion. In this example, the interaction management system 104 ingests data including audio files of agent calls with customers obtained from the enterprise data source(s) 126 in step 4100. In step 4102, the interaction management system 104 transcribes the audio (optionally via multi-lingual transcription) separating out the actors or speakers in a diarization process.

Additionally, the interaction management system 104 can also ingest data in step 4104 in this example including chats and e-mails obtained from the enterprise data source(s) 126 and issued tickets obtained from the service management platform 110. Thus, in step 4106, the interaction management system 104 extracts key issues (e.g., questions or key topics) from the text of the ingested data, as explained above. In step 4108, the interaction management system 104 generates answers from the questions extracted in step 4106, as also explained above. In step 4110, the interaction management system 104 classifies the new questions to existing topics (e.g., as generated in the step 4008 and/or 4014 of FIG. 40). If a question does not sufficiently fit into an existing topic, the interaction management system 104 adds the question to an “other” topic.

In step 4112, for the questions in the “other” topic, the interaction management system 104 creates new topic(s) and/or sub-topic(s) if the number of questions is greater than a threshold value. In step 4114, the interaction management system optionally removes questions from the vector database 3910 that are older than a predetermined number of days. In step 4116, the interaction management system 104 embeds new or updated questions and stores the same in the vector database 3910 along with associated metadata, as explained above.

Any one of the steps illustrated in FIG. 41 can be performed using one or more of the MLM(s) 3912 (e.g., an LLM). Thus, the new topics can be generated as explained above. Additionally, the steps illustrated in FIG. 41 can be performed in a different order in other examples with the result being a set of questions and answers (i.e., QA pairs), which are mapped to topics and/or sub-topics.

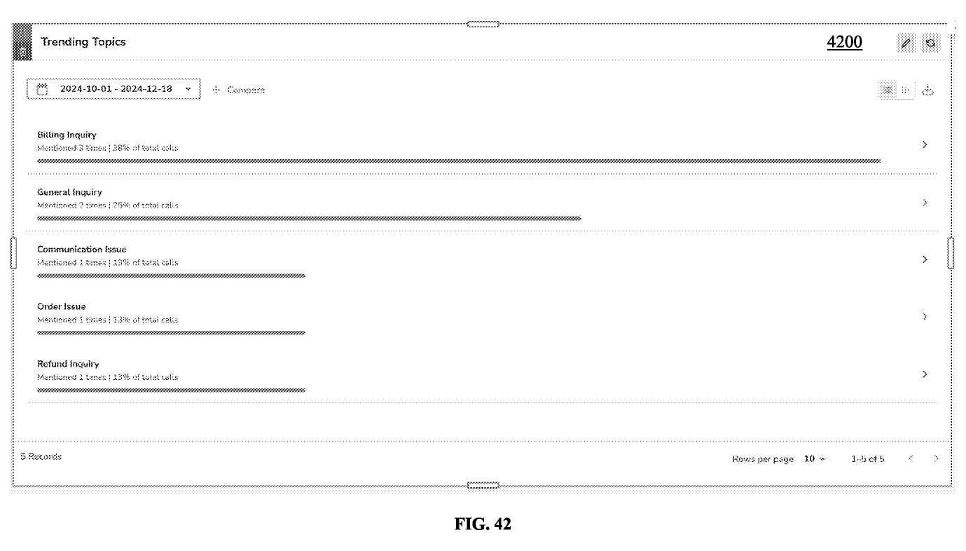

Referring to FIG. 42, a screenshot of an exemplary trending topics interface 4200 is illustrated. With the contents of the vector database 3910, in some examples, the interaction management system 104 can provide a trending topics interface 4200 upon request from one of the agent device(s) 130, for example. In this example, the trending topics include Billing Inquiry, General Inquiry, Communication Issue, Order Issue, and Refund Inquiry. Optionally, the trending topics can be ordered based on volume or number of questions classified to the topics, although other methods of organizing the topics can also be used. With the trending topics, agents can quickly identify whether a current question is associated with a topic and, if so, drill down into the answer.

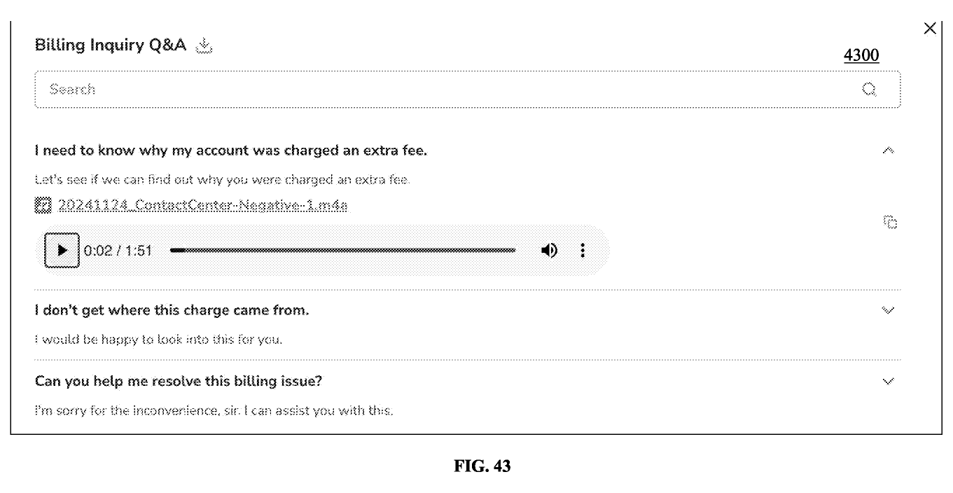

For example, referring to FIG. 43, a screenshot of an exemplary billing inquiry QA interface 4300 is illustrated. In this example, the billing inquiry QA interface 4300 can be presented in response to a selection from one of the agent device(s) 130 of the Billing Inquiry topics of the trending topics interface 4200, for example. The billing inquiry QA interface 4300 includes examples of the questions classified to the associated topic along with metadata (e.g., the question, answer, and audio of an exemplary customer interaction). The questions can optionally be ranked in the billing inquiry QA interface 4300 based on a determined importance, volume, or any other characteristic.

In one exemplary use-case, a supervisor of agents reviews trending topics and sees that one topic is becoming more frequent. He reviews the latest calls on that topic and discovers that agents do not have information in their training material that cover the topic, which allows the supervisor to update the training material, and the agents subsequently have an easier time handling those calls. In another example, agents review trending topics and see the topic and how other agents have handled similar calls, allowing them to answer customer questions more easily.

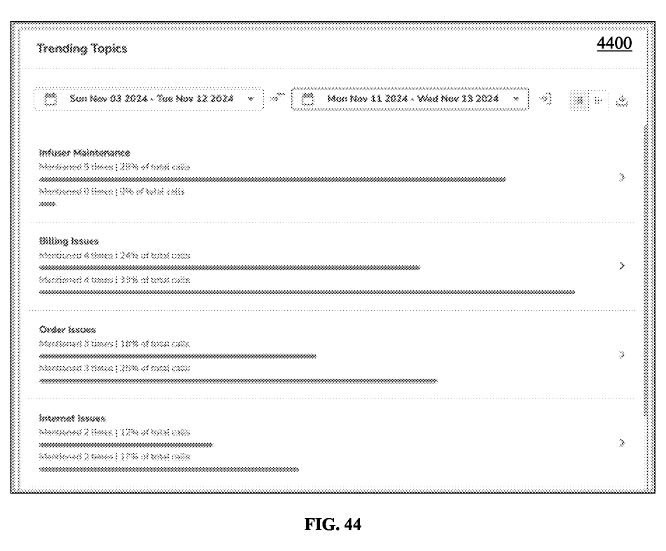

Referring to FIG. 44, a screenshot of an exemplary trending topics analytics interface 4400 is illustrated. With the vector database 3910 populated as explained above, the interaction management system 104 can also generate and provide the trending topics analytics interface 4400 upon request from one of the agent device(s) 130. In this example, a comparison is provided across trending topics between different specified time ranges. In other examples, other types of visual data representations (e.g., pie charts) can be used to provide a visual breakdown of trending topics making it easy to understand the distribution of mentions.

Additionally, agents can search the generated questions and answers in some examples (e.g., via keyword searching) to quickly locate relevant information on specific issues and more effectively satisfy a customer question. Further, the interaction management system 104 can facilitate downloading or exporting of trending topic data and related QA pair metadata for offline analysis and reporting.

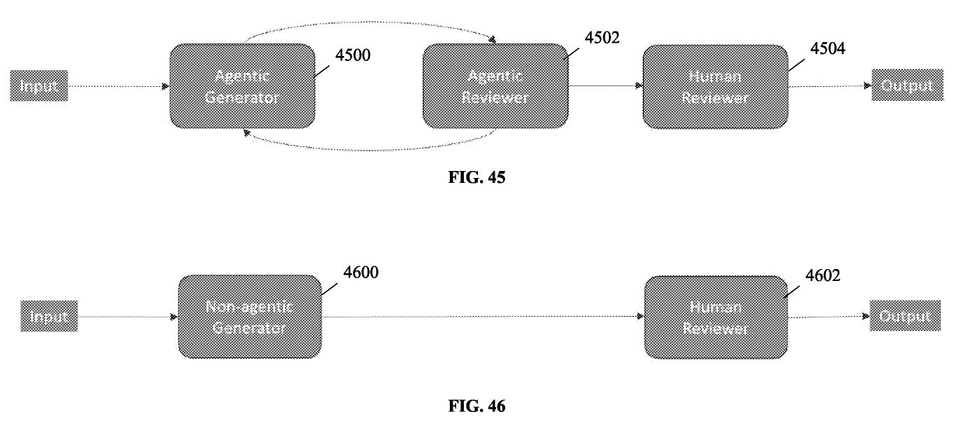

Referring to FIG. 45, a flowchart of exemplary workflow steps with a reflection pattern is illustrated. As explained above, step(s) can be performed using one or more of the MLM(s) 3912. The MLM(s) 3912 can be trained using a reflection pattern with a human in the loop to review prior to deployment to generate output as part of the interaction management system 104. In this example, an agentic generator in step 4500 takes input (e.g., ingested data relating to agent-customer interactions) and a task description and generates first output (e.g., QA pairs or set of topics) and sends the same to an agentic reviewer.

The agentic reviewer in step 4502 then takes the task description and the first output, critiques the first output, and sends the critique to the agentic generator. The agentic generator takes the input, task description, and first output critique, and generates a second output in another iteration of step 4500. The agentic reviewer will review the second output in a subsequent iteration of step 4502 and if the resulting critique satisfies an accuracy threshold, or more than a predetermined number of interactions between the agentic generator and review have been performed, then the agentic review sends the resulting output to a human reviewer. The human reviewer in step 4504 reviews and optionally edits the resulting output and can also decide the next workflow step (e.g., can override the default next step).

In other examples, the MLM(s) 3912 executed by the interaction management system 104 to perform any one of the steps previously described can be trained without reflection. In these examples, as illustrated via the flowchart of exemplary workflow steps without a reflection pattern of FIG. 46, the non-agentic generator in step 4600 takes input (e.g., ingested data relating to agent-customer interactions) and a task description and generates first output (e.g., QA pairs or set of topics) and then provides a mechanism for the human to review and edit the first output in step 4602. In yet other examples, the human is not involved in the review/editing, and the training of the MLM(s) is completely automated.

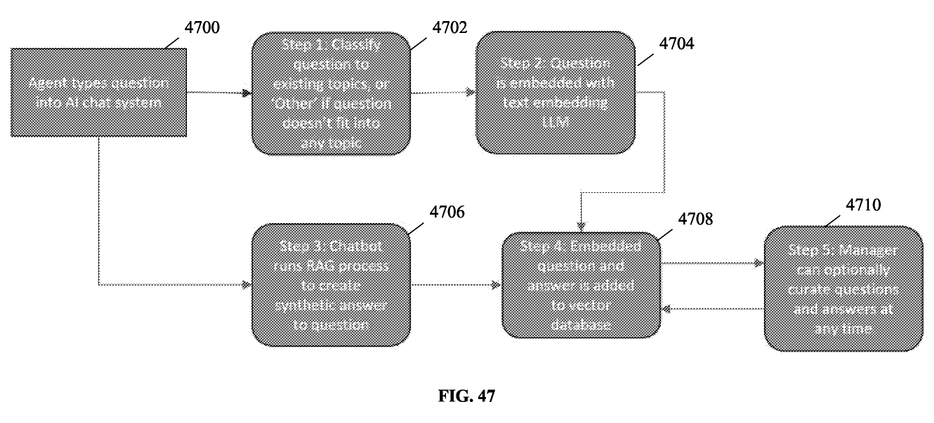

Referring now to FIG. 47, a flowchart of an exemplary method for real-time interaction updating and answer generation is illustrated. In this example, an agent in step 4700 types a question into the AI chatbot system 3900 (e.g., via one of the agent device(s) 130) and leverages the MLM(s) 3912, as described and illustrated herein. Thus, the interaction management system 104 can provide an interface of the AI chatbot system 3900 to the agent device(s) 130 over the WAN 108 and enterprise network 122. An agent can then retrieve a ticket from the service management platform 110 or a service request (e.g., a call) from one of the customer device(s) 114 and submit a related question (e.g., a reformatted version of the customer question informed by the agent’s experience) to the provided interface of the AI chatbot system 3900.

In response to the submitted question, in step 4702, the interaction management system 104 classifies the question with respect to the existing topics and/or sub-topics maintained by the interaction management system 104 or an “other” topic. The classification can be performed using one of the MLM(s) 3912, as explained in more detail above. In step 4702, the interaction management system 104 embeds the question for use in the vector database 3910. Optionally in parallel, in step 4706, the interaction management system 104 runs a RAG process to generate a synthetic answer to the submitted question using the vector database 3910 and the MLM(s) 3912.

Subsequent to steps 4702 and step 4704 in this example, the interaction management system 104 in step 4708 stores the embedded question into the vector database 3910 along with metadata (e.g., the synthetic answer, classified topic(s), sub-topic(s), date, and/or time).

Optionally, in step 4710, a manager or other human can curate questions and answers and edit the contents of the vector database 3910 accordingly.

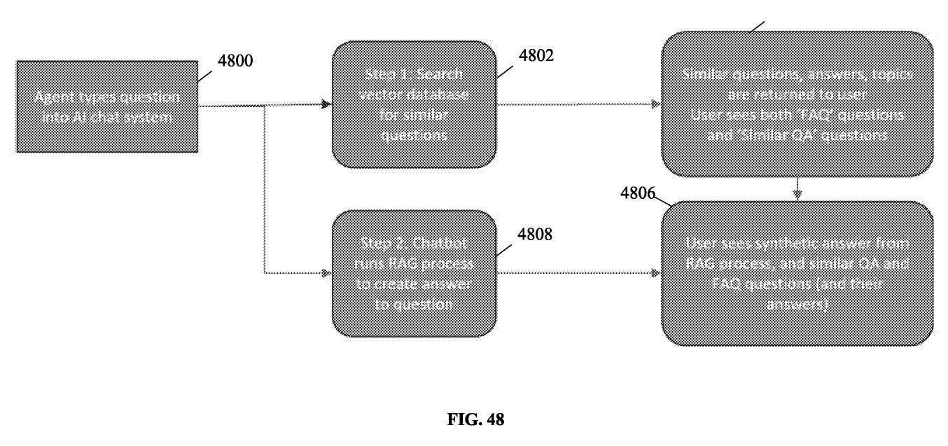

Referring to FIG. 48, a flowchart of an exemplary method for facilitating efficient service query responses based on both agent and customer QA pairs is illustrated. In this example, an agent submits a question into the AI chatbot system 3900 via one of the agent device(s) 130 in step 4800, as explained above with reference to FIG. 4700. In step 4802, the interaction management system 104 searches the vector database 3910 for similar questions, which can be performed using the MLM(s) 3912. Based on the search results, the interaction management system 104 in step 4804 identifies similar question(s), related answer(s), and associated topic(s), which are returned in step 4806 to the agent via an interface provided to the one of the agent device(s) 130.

Optionally in parallel, the interaction management system 104 in step 4808 executes a RAG process with respect to the vector database 3910 to create a synthetic answer to the question, as explained above with respect to step 4706 of FIG. 4700. The synthetic answer is then returned in step 4806 to the agent via the interface provided to the one of the agent device(s) 130. Thus, the agent is advantageously provided similar question(s) and associated answer(s), FAQ question(s) and associated answer(s) (corresponding to the identified topic(s)), and a synthetic answer in this example.

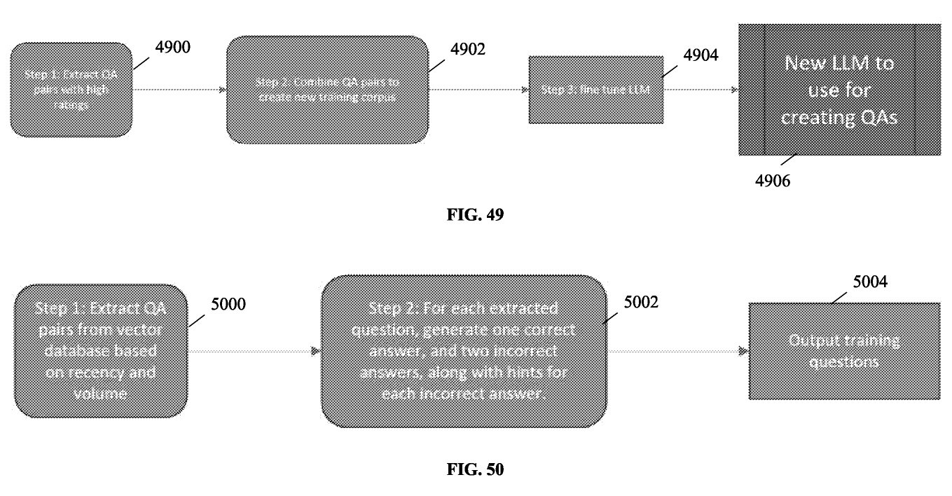

Referring now to FIG. 49, a flowchart of an exemplary method for retraining at least one of the MLM(s) 3912 is illustrated. In this example, when agents use QA pairs in an interaction (e.g., QA pairs provided as explained above with reference to FIG. 4800), the QA pairs can be upvoted or downvoted by the agents to provide feedback (e.g., regarding the accuracy, correspondence of an answer to a question, and/or success of an answer with respect to resolve a question).

The voting data is maintained by the interaction management system 104 in the memory 3904, and, in step 4900, the interaction management system 104 periodically extracts QA pairs with high ratings (e.g., QA pairs with no downvotes and greater than three upvotes, although any threshold and parameters can be used in other examples). In some examples, the method of FIG. 49 is triggered when greater than a threshold number of highly rated QA pairs are available for extraction (e.g., greater than 50).

In step 4902, the interaction management system 104 combines the QA pairs to create a new training corpus, which is used by the interaction management system 104 to fine-tune the MLM(s) 3912 in step 4904. Using the highly rated QA pairs as training examples to fine-tune the MLM(s) 3912 facilitates generation of better, more representative answers to user and/or agent questions. Thus, after the fine-tuning, the new MLM(s) 3912 are stored in the memory 3904 in step 4906 and subsequently used for creating QA pairs, as explained in more detail above.

Referring to FIG. 50, a flowchart of an exemplary method for generating training materials is illustrated. In step 5000 in this example, the interaction management system 104 extracts QA pairs from the vector database 3910 based on recency and/or volume, although other parameters can be used to guide the extraction in other examples. For example, a predetermined number of the most-recently generated or accessed similar or synthetic QA pairs can be extracted. In another example, the QA pairs having the highest volume of generation or access in a predetermined prior time period can be extracted.

For each of the extracted QA pairs, the interaction management system 104 in step 5002 generates a sample question (e.g., from one of the QA pairs), one correct answer, and any number of incorrect answers, optionally along with hints for each of the incorrect answers. The interaction management system 104 then generates training materials in step 5004 based on the generated questions, correct answers, and incorrect answers. The training materials can be provided to new agents, for example, via the AI chatbot system 3900 or exported for use in another training or onboarding tool. Training materials generated as described and illustrated herein will be more effective and representative of the most relevant and/or impactful questions agents may face in their interactions with customers.

Accordingly, as described and illustrated by way of the examples herein, this technology advantageously and significantly reduces FAQ and trending topic creation and update time. The knowledgebase and vector database 3910 developed and maintained according to this technology is improved and more effective to facilitate efficient and accurate handling of customer questions. In particular, agents have the benefit of curated similar historical QA pairs associated with other agents (e.g., via vector database query and/or topic and sub-topic hierarchy) and/or synthetic answers to questions posed by customers. Moreover, the knowledgebase facilitated by this technology can be advantageously leveraged to generate more effective agent training materials.

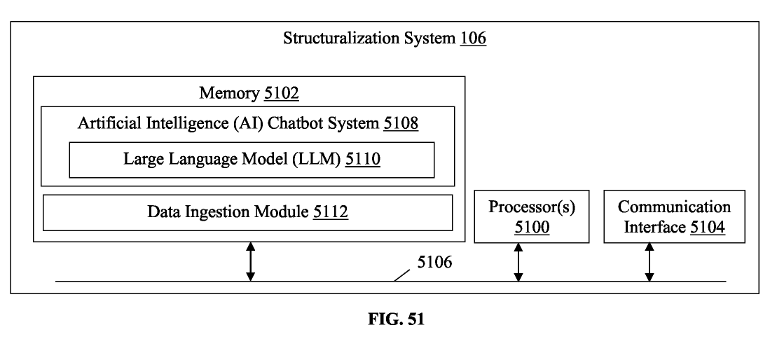

Referring back to FIG. 1 and FIG. 51, other examples of this technology will now be described with reference to the structuralization system 106. Data entry for repeated tasks is time-consuming, cumbersome, and can be complex, requiring users to maintain the state of the data entry task. Data entry in field service operations requires the use of hands while also communicating the information to be entered, which is often challenging for workers. Additionally, workers are often insufficiently trained on data entry tasks. Many data entry tasks can be predefined in terms of what data fields and database schema need to be completed to ingest high quality data. Some data entry tasks have dynamic schema for which high quality needs to be maintained as the schema is updated, without being completely freeform input. Additionally, the database schema may need to be defined in real-time or just-in-time.

Moreover, some data entry tasks dynamically depend on their definition according to the use of the data by downstream external systems. For example, if a data entry task needs to store data into a Salesforce.com^{TM} application programming interface (API), it will need one schema, but if the data needs to be sent to a ServiceNow^{TM} API it will need to have a different schema. Additionally, validation of data entry is an important step in generating high quality, low error rate information. Unfortunately, current data entry systems are inefficient and ineffective to maintain high quality data with low error rates that can yield meaningful insights for downstream users.

The disclosed technology provides several advantages including methods, non-transitory computer readable media, and structuralization systems that facilitate improved and more efficient data entry aligned with a database schema, which is ingested or dynamically generated, in order to yield improved downstream insights and accurate database query results. In one example, the structuralization system 106 is a server or other computing device. While the data entry user device(s) 132, analytics user device(s) 128, enterprise data source(s) 126, database 116, and structuralization system 106 are disclosed in FIG. 1 as dedicated hardware devices, one or more of the data entry user device(s) 132, analytics user device(s) 128, enterprise data source(s) 126, database 116, or structuralization system 106 can also be implemented in software within one or more other devices in the network environment 100. As one example, the structuralization system 106 can be implemented in software or as a virtual server hosted by the same hardware device as the database 116, and many other permutations and types of implementations can also be used in other examples.

The structuralization system 106 of the network environment 100 may perform any number of functions as described and illustrated by way of the examples herein. The structuralization system 106 in this example includes processor(s) 5100, memory 5102, and a communication interface 5104, which are coupled together by a bus 5106, although the structuralization system 106 can include other types or numbers of elements in other configurations.

The processor(s) 5100 of the structuralization system 106 may execute programmed instructions stored in the memory 5102 of the structuralization system 106 for any number of the functions described and illustrated herein. The processor(s) 5100 may include one or more central processing units or with one or more processing cores, for example, although other types of processor(s) can also be used.

The memory 5102 of the structuralization system 106 stores these instructions for one or more aspects of the present technology as described and illustrated herein, although some or all of the instructions could be stored elsewhere. A variety of different types of memory storage devices, such as RAM, ROM, hard disk, solid state drives, flash memory, or other computer readable medium which is read from and written to by a magnetic, optical, or other reading and writing system that is coupled to the processor(s) 5100, can be used for the memory 5102.

Accordingly, the memory 5102 of the structuralization system 106 can store one or more applications that can include computer executable instructions that, when executed by the structuralization system 106, cause the structuralization system 106 to perform actions, such as to transmit, receive, or otherwise process network messages and requests, for example, and to perform other actions described and illustrated below. The application(s) can be implemented as components of other applications, operating system extensions, and/or plugins, for example.

Further, the application(s) may be operative in a cloud-based computing environment. The application(s) can be executed within or as virtual machine(s) or virtual server(s) that may be managed in a cloud-based computing environment. Also, the application(s), and even the structuralization system 106 itself, may be located in virtual server(s) running in a cloud-based computing environment rather than being tied to one or more specific physical network computing devices. Also, the application(s) may be running in one or more virtual machines (VMs) executing on the structuralization system 106. Additionally, in one or more examples of this technology, virtual machine(s) running on the structuralization system 106 may be managed or supervised by a hypervisor.

In this example, the memory 5102 of the structuralization system 106 includes an AI chatbot system 5108 with at least one large language model (LLM) 5110 and an optional data ingestion module 5112, although other types or another number of modules or applications can be provided in other examples. The data ingestion module 5112 is configured to obtain a corpus of information in the form of audio data and/or call logs and/or transcripts of interactions or interviews, for example, which can be obtained from the data source(s).

In some examples, the AI chatbot system 5108 leveraging the LLM 5110 analyzes the ingested data, as described and illustrated in detail below, to structuralize the data according to the schema 118. In other examples, the AI chatbot system 5108 is configured to facilitate a voice or chat exchange or interaction, such as with the data entry user device(s) 132, based on a generated prompt and using the LLM 5110, to ingest content and store the content in the database 116 in a structured manner in accordance with the schema 118 to facilitate more effective downstream insights, analytics, and other types of data processing and analysis.

The communication interface 5104 of the structuralization system 106 operatively couples and communicates between the structuralization system 106 and the enterprise data source(s) 126, database 116, analytics user device(s) 128, and data entry user device(s) 132, which are coupled together at least in part by the WAN 108 and enterprise network 122, although other types or another number of communication networks or systems with other types or numbers of connections or configurations to other devices or elements can also be used.

While the structuralization system 106 is illustrated in this example as including a single device, the structuralization system 106 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the structuralization system 106. Additionally, one or more of the devices that together comprise the structuralization system 106 in other examples can be standalone devices or integrated with one or more other devices or apparatuses.

Each of the data entry user device(s) 132 and analytics user device(s) 128 of the network environment 100 in this example includes any type of computing device that can exchange network data, such as mobile, desktop, laptop, or tablet computing devices, virtual machines (including cloud-based computers), or the like. Each of the data entry user device(s) 132 and analytics user device(s) 128 includes a processor, a memory, and a communication interface, which are coupled together by a bus or other communication link (not illustrated), although other numbers or types of components could also be used.

Each of the data entry user device(s) 132 and analytics user device(s) 128 may run interface applications, such as standard web browsers or standalone client applications, which may provide an interface to communicate with the structuralization system 106 via the WAN 108 and/or enterprise network 122. Each of the data entry user device(s) 132 and analytics user device(s) 128 may further include a display device, such as a display screen or touchscreen, or an input device, such as a keyboard or mouse, for example (not illustrated).

In some examples, the data entry user device(s) 132 are associated with field service workers that may need to record a checklist of performed tasks for compliance purposes or otherwise submit data that can be used by an associated enterprise. To use the ingested data, which is structuralized as described and illustrated herein, the analytics user device(s) 128 can be used by managers or supervisors to extract insights from the data, for example. In other examples, other types of users can facilitate data entry, and the stored structured data can be used for any other purpose by other users.

Although the exemplary network environment 100 with the data entry user device(s) 132, analytics user device(s) 128, enterprise data source(s) 126, database 116, structuralization system 106,WAN 108, and enterprise network 122 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in the network environment 100, such as the data entry user device(s) 132, analytics user device(s) 128, enterprise data source(s) 126, database 116, or structuralization system 106, for example, may be configured to operate as virtual instances on the same physical machine. In other words, one or more of the data entry user device(s) 132, analytics user device(s) 128, enterprise data source(s) 126, database 116, or structuralization system 106 may operate on the same physical device rather than as separate devices communicating through the WAN 108 and/or enterprise network 122. Additionally, there may be more or fewer data entry user devices, analytics user devices, data sources, databases, and/or structuralization systems than illustrated in FIG. 1.

The examples of this technology may also be embodied as one or more non-transitory computer readable media having instructions stored thereon, such as in the memory 5102, for one or more aspects of the present technology, as described and illustrated by way of the examples herein. The instructions in some examples include executable code that, when executed by one or more processors, such as the processor(s) 5100, cause the processors to carry out steps necessary to implement the methods of the examples of this technology that are described and illustrated herein.

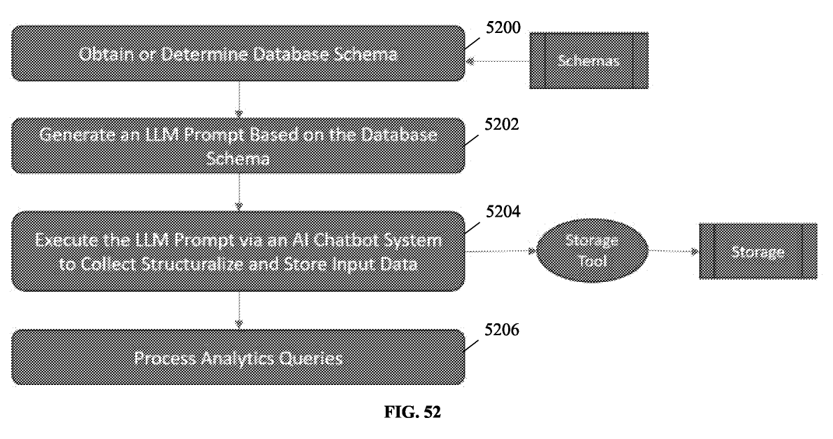

Referring to FIG. 52, a flowchart of an exemplary method for voice-enabled natural language structuralized data entry is illustrated. In this example, the structuralization system 106 in step 5200 obtains or determines the schema 118. The database 116 can be a structured query language (SQL) database or any other type of data store. In some examples, the schema 118 can be predefined and retrieved from the database 116 or an associated database management system, for example. In other examples, the schema 118 can be inferred from an API or webhook (e.g., based on the associated parameters). In yet other examples, the schema 118 can be dynamically derived based on an application of the LLM 5110 to questions and answers obtained by the AI chatbot system 5108 or content retrieved from the enterprise data source(s) 126.

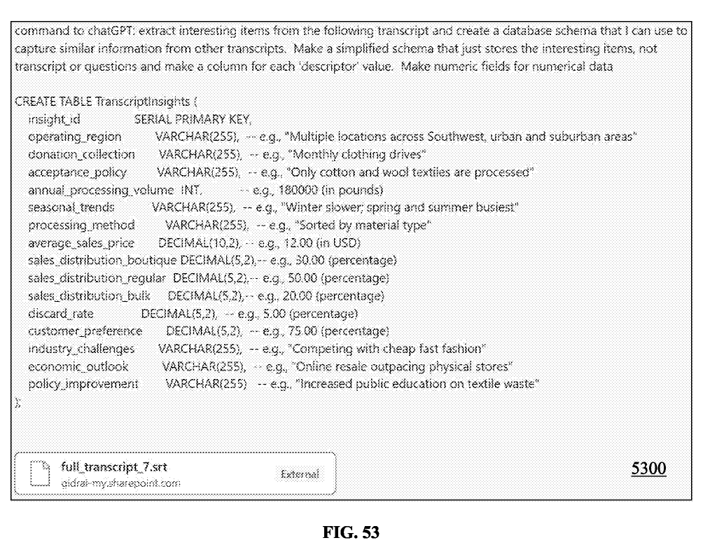

Referring to FIG. 53, an exemplary prompt 5300 to the LLM 5110 that is configured to cause the LLM 5110 to generate the schema 118 is illustrated. In this example, the structuralized system 106 is configured to retrieve a transcript document from the enterprise data source(s) 126and prompt the LLM 5110 to analyze the transcript document to generate a schema 118 from transcript document content. The schema 118 is generated based on interesting items and the prompt 5300 instructs the LLM 5110 to make numeric fields for numerical data. The resulting schema 118 is a table with particular columns determined dynamically from the content of the transcript file.

In still other examples, the schema 118 can be generated based on defined enumerations for specific table columns that specify a limited set of options or entries (e.g., a list of Salesforce^{TM} widgets, a list of URLs, or a set of addresses). The enumeration in some examples can have a field for value and a natural language definition (e.g., url:”www.foo.com/blah?bar=baz”, text: “A salesforce tool to enter pursuits that were unsuccessful.”).

The columns can be specified for the structuralization system 106 to fill in and/or the schema 118 can define an order in which data should be input so as to make logical sense to users of the data entry user device(s) 132 (e.g., input Name before Description for a task). Combinations of the above methods for obtaining or generating the schema 118, and/or other methods for obtaining or generating the schema 118, can also be used in other examples.

Referring back to FIG. 52, in step 5202, the structuralization system 106 generates an LLM prompt based on the schema 118. The LLM prompt is configured to cause the LLM 5110 to collect input data in a stepwise manner, structuralize the input data, and insert the structuralized input data into the database 116. Thus, the LLM prompt includes at least the schema 118 obtained or generated in step 5200 along with instructions to guide a user (e.g., via a voice or text chat interface provided by the AI chatbot system 5108 to one of the data entry user device(s) 132) to enter data in a stepwise sequential manner that facilitates structuralization. Accordingly, the prompt includes instructions for a generative language model such as the LLM 5110 to ask a user, in question-and-answer format, to submit data or other content for each of the data fields needed by the schema, one by one.

Optionally, in some examples, more than one schema is available, in which case the structuralization system 106 can be configured to generate the prompt to cause the AI chatbot system 5108 to ask the user which data entry task needs to be performed and choose the appropriate database schema for that data entry task. In other examples, the LLM prompt can include instructions to validate the data and associated data type before it determines that the data entry for a particular field has been successfully provided or completed. Additionally, a tool or function can be defined by the structuralization system 106 to cause the AI chatbot system 1508 to retrieve a schema from a store of schemas based on user intent or another parameter.

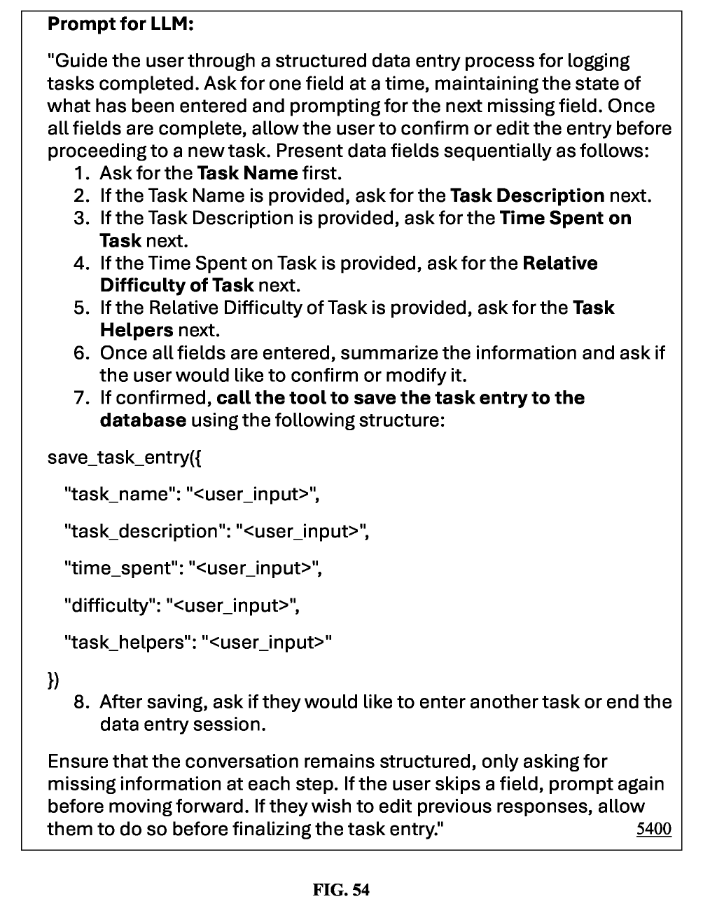

Referring now to FIG. 54, an exemplary prompt 5400 to the LLM 5110 is illustrated. In this example, the prompt 5400 is for data entry with stepwise input collection for task entries that have identified fields corresponds to the schema 118 columns, which are provided to the LLM 5110 as part of the prompt 5400. Thus, the prompt 5400 instructs the LLM 5110 to log tasks completed by asking for one field at a time, and present data fields of the schema 118 sequentially. Additionally, the prompt 5400 in this example allows for re-prompting if a field is skipped, editing previous responses, and requiring the user (e.g., of one of the data entry user device(s) 132) to confirm that the task is adequately entered before ending the data entry session and storing the ingested data.

In other examples, the data dictionary 120 can also be obtained or generated in step 5200 and/or included in the prompt generated in step 5202. The data dictionary 120 includes a natural language description of each column identified in the schema 118. Thus, in examples in which the schema 118 may be established and may use column names or identifiers that are not in a natural language format, the data dictionary 120 can be leveraged by the prompt and LLM 5110 to correlate the columns of the schema 118 with the ingested data.

In other examples, the prompt can be configured to dynamically extend the schema 118 over time during data ingestion. For example, the prompt can be configured to cause the LLM 5110 to perform the named entity identification described and illustrated above with reference to FIG. 53 during each iteration of data ingestion to determine whether new columns should be added to the schema 118 (e.g., based on a frequency of related content). In these examples, the structuralization system 106 can be preconfigured to define the database 116 as a tool and to communicate with the database 116 to extend the schema 118 (e.g., add column(s) to particular table(s)).

Referring back to FIG. 52, in step 5204, the structuralization system 106 executes the prompt via the AI chatbot system 5108 to collect, structuralize, and store input data in the database 116. The execution of the prompt can be initiated by a user of one of the data entry user device(s) 132, for example, although the execution can be initiated in other ways by users of other devices. The data ingested based on execution of the prompt can be in a natural language and can be structuralized in accordance with the schema 118 of the prompt. The structuralized ingested data (e.g., a data row) can then be inserted into the database 116 in a structured manner based on the schema 118 and a preconfigured connection between the structuralization system 106 (or AI chatbot system 5108 thereof) and the database 116.

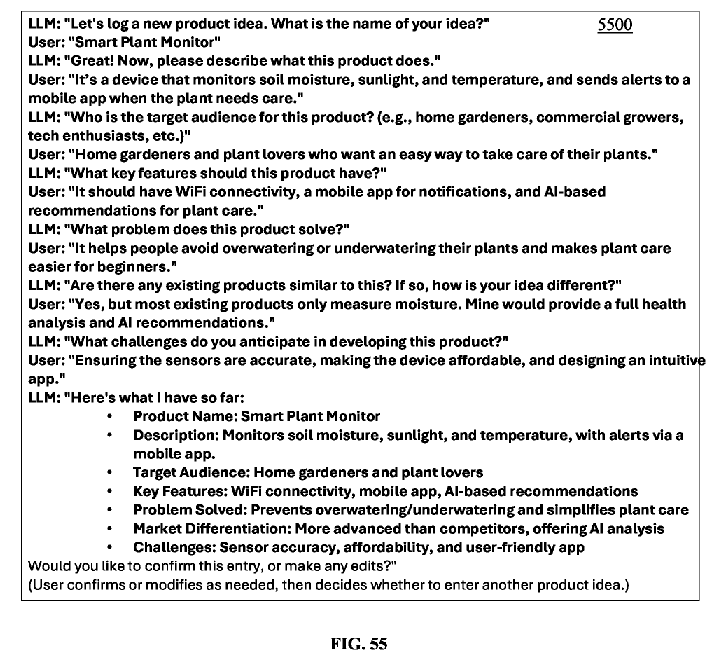

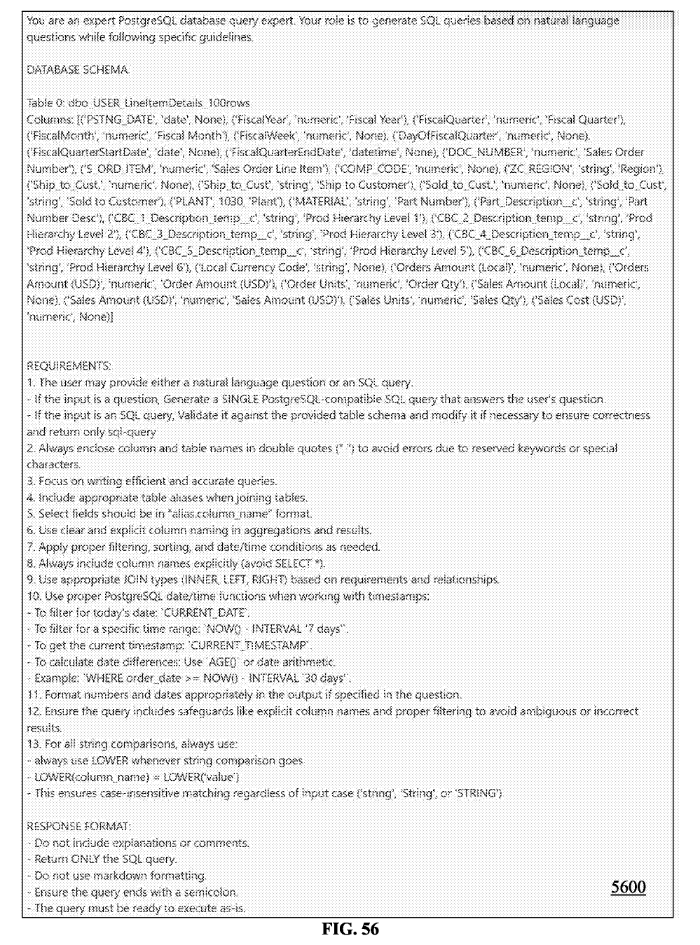

Referring to FIG. 55, an exemplary transcript 5500 of an interaction between the AI chatbot system 5108 and a user of one of the data entry user device(s) 132 resulting from prompt execution is illustrated. In this exemplary use-case of the disclosed technology, a company wants to make a tool for their employees to record ideas for new products, which is to be easy to use and have very low friction. The company provides a smartphone application that the user just has to open and speak into in a natural language to record their new product idea. Thus, the smartphone is one of the data entry user device(s) 132 in this example.

The user is walking back from lunch and has a great new product idea. Accordingly, the user executes their smartphone applications, which is configured to facilitate an interaction with the AI chatbot system 5108 executing a prompt previously generated for the LLM 5110. As illustrated in FIG. 55, the AI chatbot system 5108 (referred to in FIG. 55 as “LLM”) asks a series of questions in accordance with a prompt executed by the smartphone application and the user responds to each question with an answer. The AI chatbot system 5108 then summarizes the information ingested, as instructed by the prompt, and asks whether the user would like to confirm the new product idea entry or edit any of the provided information.

Referring back to FIG. 52, in step 5206, the structuralization system 106 processes analytics queries (e.g., from the analytics user device(s) 128) to thereby take advantage of the structuralization of the ingested data to yield improved performance and more accurate database query results and insights. Referring to FIG. 56, an exemplary prompt 5600 to the LLM 5110 or a different LLM is illustrated that queries the database 116 in accordance with a provided schema (e.g., schema 118). In this example, a user of one of the analytics user device(s) 128 may execute an application to cause the one of the analytics user device(s) 128 to interface with the structuralization system 106 or another third-party system communicably coupled to the database 116.

The interaction with the user is guided by the prompt 5600 to require a natural language or SQL query such that if the query is a natural language query the prompt 5600 results in generation of a SQL query in a text-to-SQL operation. The generation of the SQL query is informed by the schema 118 provided with the prompt 5600, which could have also been used previously for structuralized data ingestion into the database 116. Thus, the SQL query provided in response to execution of the prompt of FIG. 56 is more effective to retrieve responsive data from the database 116. The returned SQL query can be automatically executed by the same device executing the prompt 5600 in some examples and/or can be utilized by another downstream computing device to retrieve and provide responsive data to users of the analytics user device(s) 128.

Accordingly, as described and illustrated by way of the examples herein, this technology advantageously structuralizes natural language and other types of content in a more efficient manner to yield a more robust database that can be used to generate improved query responses and associated insights and analytics. This technology facilitates more efficient data entry, particularly for repeated tasks and particularly for field service and other workers for which natural language and/or voice data entry is advantageous.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meaning as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method implemented by one or more conversational artificial intelligence systems, the method comprising:
generating a guided procedure by applying one or more machine learning models to enterprise data obtained from one or more enterprise data sources via one or more communication networks and, wherein the guided procedure comprises a plurality of steps each associated with one or more required structured fields and at least one validator;
monitoring interaction with a conversational agent application at a user device during execution of the guided procedure by a user of the user device to maintain a procedure state vector comprising at least an indication of a current one of the steps and a completion status for the required structured fields;
analyzing evidence data obtained via the conversational agent application against at least one rule of the validator for the current one of the steps to determine that the rule is satisfied, wherein the conversational agent application is configured to prompt the user to submit the evidence data based on an evidence type of the validator for the current one of the steps;
updating the procedure state vector to thereby permit the conversational agent application to proceed to a next one of the steps upon determining, based on the monitoring, that each of the required structured fields for the current one of the steps has been completed; and
storing an auditable execution record upon determining via the conversational agent application that the guided procedure has been completed, wherein the auditable execution record comprises the completion statuses, the evidence data, and metadata associated with completion of the guided procedure.

2. The method of claim 1, wherein the required structured fields collectively comprise a checklist, the evidence data comprises an image, and the method further comprises applying another one or more machine learning models to the image to determine whether the rule is satisfied.

3. The method of claim 1, wherein the metadata comprises one or more of an identity of the user, a location of the user device upon completion of the guided procedure, or a time of completion of the guided procedure.

4. The method of claim 1, further comprising automatically ordering a part via an application programming interface to a third-party part supplier system when an inventory level of the part is determined to be below a threshold based on a query to a parts inventory system, wherein the part is identified as required for the guided procedure based on a service ticket obtained from a service ticket platform.

5. The method of claim 1, further comprising generating, and outputting via the communication networks to another user device for display in response to an audit request received from the other user device, an audit trail dashboard comprising at least a portion of the auditable execution record and at least another portion of a plurality of other auditable execution records associated with other guided procedures and other users.

6. The method of claim 1, wherein one of the completion statuses indicates a failure and the method further comprises generating and providing compliance data in response to a compliance request received from another user device via the communication networks, wherein the compliance request includes an identity of the user and the one of the completion statuses retrieved from the auditable execution record based on the identity of the user.

7. The method of claim 6, wherein one of the completion statuses indicates a failure and the method further comprises applying another one or more machine learning models to the enterprise data to generate training data for the user and the guided procedure based at least in part on the one of the completion statuses, wherein the training data comprises one or more best practices associated with the guided procedure, one or more core principles for achieving compliance with respect to the guided procedure, or an enhancement procedure comprising a plurality of other steps.

8. A conversational artificial intelligence system, comprising memory having instructions stored thereon and one or more processors configured to execute the stored instructions to:
generate a guided procedure by applying one or more machine learning models to enterprise data obtained from one or more enterprise data sources via one or more communication networks and, wherein the guided procedure comprises a plurality of steps each associated with one or more required structured fields and at least one validator;
monitor interaction with a conversational agent application at an user device during execution of the guided procedure by a user of the user device to maintain a procedure state vector comprising at least an indication of a current one of the steps and a completion status for the required structured fields;
analyze evidence data obtained via the conversational agent application against at least one rule of the validator for the current one of the steps to determine that the rule is not satisfied, wherein the conversational agent application is configured to prompt the user to submit the evidence data based on an evidence type of the validator for the current one of the steps;
update the procedure state vector to thereby permit the conversational agent application to proceed to a next one of the steps upon determining, based on the monitoring, that each of the required structured fields for the current one of the steps has been completed and the rule has been satisfied in a subsequent iteration based on other evidence data; and
store an auditable execution record upon determining via the conversational agent application that the guided procedure has been completed, wherein the auditable execution record comprises the completion statuses, the evidence data, and metadata associated with completion of the guided procedure and one of the completion statuses for the current one of the steps indicates a failure.

9. The conversational artificial intelligence system of claim 8, wherein the metadata comprises one or more of an identity of the user, a location of the user device upon completion of the guided procedure, or a time of completion of the guided procedure.

10. The conversational artificial intelligence system of claim 8, wherein the evidence data comprises one or more of a video, sensor measurement, timestamp, or location and the enterprise data comprises one or more user manuals, service manuals, or product documentation.

11. The conversational artificial intelligence system of claim 8, wherein the processors are further configured to execute the stored instructions to generate, and output via the communication networks to another user device for display in response to an audit request received from the other user device, an audit trail dashboard comprising at least a portion of the auditable execution record and at least another portion of a plurality of other auditable execution records associated with other guided procedures and other users.

12. The conversational artificial intelligence system of claim 8, wherein the processors are further configured to execute the stored instructions to generate and provide compliance data in response to a compliance request received from another user device via the communication networks, wherein the compliance request includes an identity of the user and the one of the completion statuses retrieved from the auditable execution record based on the identity of the user.

13. The conversational artificial intelligence system of claim 8, wherein the processors are further configured to execute the stored instructions to apply another one or more machine learning models to the enterprise data to generate training data for the user and the guided procedure based at least in part on the one of the completion statuses.

14. One or more non-transitory computer readable media having stored thereon instructions comprising executable code that, when executed by one or more processors, causes the processors to:
generate a guided procedure by applying one or more machine learning models to enterprise data obtained from one or more enterprise data sources via one or more communication networks and, wherein the guided procedure comprises a plurality of steps each associated with one or more required structured fields and at least one validator;
monitor interaction with a conversational agent application at a user device during execution of the guided procedure by a user of the user device to maintain a procedure state vector comprising at least an indication of a current one of the steps and a completion status for the required structured fields, wherein the required structured fields collectively comprise a checklist;
analyze an image obtained via the conversational agent application against at least one rule of the validator for the current one of the steps based on an application of another one or more machine learning models to the image to determine that the rule is satisfied, wherein the conversational agent application is configured to prompt the user to submit the image based on an evidence type of the validator for the current one of the steps;
update the procedure state vector to thereby permit the conversational agent application to proceed to a next one of the steps upon determining, based on the monitoring, that each of the required structured fields for the current one of the steps has been completed; and
store an auditable execution record upon determining via the conversational agent application that the guided procedure has been completed, wherein the auditable execution record comprises the completion statuses, the image, and metadata associated with completion of the guided procedure.

15. The non-transitory computer readable media of claim 14, wherein the metadata comprises one or more of an identity of the user, a location of the user device upon completion of the guided procedure, or a time of completion of the guided procedure.

16. The non-transitory computer readable media of claim 14, wherein the executable code, when executed by the processors, further causes the processors to automatically order a part via an application programming interface to a third-party part supplier system when an inventory level of the part is determined to be below a threshold based on a query to a parts inventory system, wherein the part is identified as required for the guided procedure based on a service ticket obtained from a service ticket platform.

17. The non-transitory computer readable media of claim 14, wherein the executable code, when executed by the processors, further causes the processors to generate, and output via the communication networks to another user device for display in response to an audit request received from the other user device, an audit trail dashboard comprising at least a portion of the auditable execution record and at least another portion of a plurality of other auditable execution records associated with other guided procedures and other users.

18. The non-transitory computer readable media of claim 14, wherein one of the completion statuses indicates a failure and the executable code, when executed by the processors, further causes the processors to generate and provide compliance data in response to a compliance request received from another user device via the communication networks, wherein the compliance request includes an identity of the user and the one of the completion statuses retrieved from the auditable execution record based on the identity of the user.

19. The non-transitory computer readable media of claim 14, wherein one of the completion statuses indicates a failure and the executable code, when executed by the processors, further causes the processors to apply another one or more machine learning models to the enterprise data to generate training data for the user and the guided procedure based at least in part on the one of the completion statuses.

20. The non-transitory computer readable media of claim 19, wherein the training data comprises one or more best practices associated with the guided procedure, one or more core principles for achieving compliance with respect to the guided procedure, or an enhancement procedure comprising a plurality of other steps.
